(19) United States
(12) Patent Application Publication
(10) Pub. No.: US 2023/0132033 A1
(43) Pub. Date: Apr. 27, 2023

(54) AUTOMATICALLY GENERATING, REVISING, AND/OR EXECUTING TROUBLESHOOTING GUIDE(S)

(71) Applicant: Microsoft Technology Licensing, LLC, Redmond, WA (US)

(72) Inventors: Anurag GUPTA, Sammamish, WA (US); Eric Thomas LANGLAND, Vashon Island, WA (US); Ryan Wayne RIFE, Maple Valley, WA (US); Joshua John WHATLEY, Seattle, WA (US)

(21) Appl. No.: 17/508,920

(22) Filed: Oct. 22, 2021

(51) Int. Cl. G06F 8/73; G06F 16/93; G06K 9/62; G06N 20/00

(52) U.S. Cl. CPC G06F 8/73; G06F 16/93; G06K 9/623; G06N 20/00

(57) ABSTRACT

Techniques are described herein that are capable of automatically generating, revising, and/or executing troubleshooting guide(s). In a first example, an operation is selected based at least in part on a schema and information indicating that the operation is capable of mitigating a category of issues. In a second example, information is analyzed to identify operations performed with regard to service(s) to mitigate issues, and an operation is selected based at least in part on the information indicating that the operation is capable of mitigating a category of issues that includes an identified issue. In these examples, an executable troubleshooting guide is automatically generated to perform the selected operation. In a third example, weights are assigned to features that are extracted from data associated with troubleshooting guide(s), and a subset of the troubleshooting guide(s) is automatically revised based at least in part on the weights corresponding to the subset.

### BACKGROUND

A troubleshooting guide is a document (e.g., an electronic document or a physical document) that is usable to facilitate identification and/or resolution of one or more issues regarding code (e.g., a service) and/or an application programming interface (API). For instance, the troubleshooting guide may be used or configured to diagnose and/or resolve the one or more issues. An example of such an issue is a bug (e.g., defect) in the code and/or the API. For instance, the bug may be encountered during execution of the code or during utilization of the API. Another example of such an issue is an infrastructure-related problem encountered by the code and/or the API. For instance, a service may not be operational because a network device has gone down.

If an issue is encountered with regard to code or an API, a troubleshooting guide may not exist to facilitate identification or resolution of the issue. Even if such a troubleshoot guide exists, the troubleshooting guide may be of relatively low quality. For instance, troubleshooting guides often are incomplete, include errors, and/or include subjective (e.g., ambiguous) language. The relatively low quality of the troubleshooting guides may negatively affect productivity of engineers who use the troubleshooting guides, increase a cost of performing operations using the troubleshooting guides, and/or lead to an outage of the code or the API with which the troubleshooting guides are associated. Engineers may manually perform ad hoc changes to troubleshooting guides in an effort to increase the quality of the troubleshooting guides. However, the ad hoc changes may not be optimized, safe, or secure.

### SUMMARY

Various approaches are described herein for, among other things, automatically generating, revising, and/or executing troubleshooting guide(s). A troubleshooting guide may be automatically generated based on a determination that a troubleshooting guide regarding a service or regarding an issue (e.g., a potential issue) associated with the service does not exist. For instance, a search may be performed to locate the troubleshooting guide, and a failure to locate the troubleshooting guide may result in the troubleshooting guide being automatically generated. A troubleshooting guide may be automatically revised based on a determination that the troubleshooting guide does not satisfy one or more criteria. For instance, the troubleshooting guide may be analyzed (e.g., as a result of discovering the troubleshooting guide or in accordance with a pre-defined schedule) to make the determination. A troubleshooting guide may be automatically executed based on a determination that an issue addressed by the troubleshooting guide has occurred, or the troubleshooting guide may be automatically executed as a preemptive measure to avoid occurrence of an issue.

In an example approach of automatically generating an executable troubleshooting guide, a schema is determined. The schema defines at least a subset of operations that are capable of being performed with regard to a service. A mitigation operation is selected from the operations defined by the schema based at least in part on historical information, which indicates historical operations that have been performed previously to mitigate issues associated with the service, indicating that the mitigation operation is capable of mitigating at least a subset (e.g., an entirety) of a category of issues. The executable troubleshooting guide, which is configured to perform the mitigation operation, is automatically generated as a result of selecting the mitigation operation from the operations.

In another example approach of automatically generating an executable troubleshooting guide, an issue that occurs with regard to a service is identified. Historical information is analyzed to identify historical operations that have been performed previously with regard to one or more services to mitigate issues associated with the one or more services. A mitigation operation is selected from the historical operations based at least in part on the historical information indicating that the mitigation operation is capable of mitigating a category of issues that includes the issue. The executable troubleshooting guide, which is configured to perform the mitigation operation, is automatically generated as a result of selecting the mitigation operation from the historical operations.

In an example approach of automatically revising at least one troubleshooting guide, features are extracted from data associated with troubleshooting guide(s) that are associated with code and/or an application programming interface (API). Each troubleshooting guide includes instructions that describe operations to be performed to resolve issues associated with the code and/or the API. Each feature indicates an attribute of at least one of the troubleshooting guide(s). Weights are assigned to the respective features. A subset of the troubleshooting guide(s) is automatically revised based at least in part on the weights assigned to the respective features that correspond to the subset of the troubleshooting guide(s) to increase quality of each troubleshooting guide in the subset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example troubleshooting guide system in accordance with an embodiment.

FIGS. 2-6 and 8-11 depict flowcharts of example methods for automatically generating an executable troubleshooting guide in accordance with embodiments.

FIGS. 7 and 12 are block diagrams of example computing systems in accordance with embodiments.

FIG. 13 depicts a flowchart of an example method for automatically revising troubleshooting guide(s) in accordance with an embodiment.

FIG. 14 is a block diagram of another example computing system in accordance with an embodiment.

FIGS. 15-16 depict example troubleshooting guides in accordance with embodiments.

FIG. 17 depicts an example graphical user interface that solicits explicit feedback from a user of a troubleshooting guide in accordance with an embodiment.

FIG. 18 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, and “third” are used to reference some elements discussed herein. Such descriptors are used to facilitate the discussion of the example embodiments and do not indicate a required order of the referenced elements, unless an affirmative statement is made herein that such an order is required.

### II. EXAMPLE EMBODIMENTS

Example embodiments described herein are capable of automatically generating, revising, and/or executing troubleshooting guide(s). A troubleshooting guide may be automatically generated based on a determination that a troubleshooting guide regarding a service or regarding an issue (e.g., a potential issue) associated with the service does not exist. For instance, a search may be performed to locate the troubleshooting guide, and a failure to locate the troubleshooting guide may result in the troubleshooting guide being automatically generated. A troubleshooting guide may be automatically revised based on a determination that the troubleshooting guide does not satisfy one or more criteria. For instance, the troubleshooting guide may be analyzed (e.g., as a result of discovering the troubleshooting guide or in accordance with a pre-defined schedule) to make the determination. A troubleshooting guide may be automatically executed based on a determination that an issue addressed by the troubleshooting guide has occurred, or the troubleshooting guide may be automatically executed as a preemptive measure to avoid occurrence of an issue.

Example techniques described herein have a variety of benefits as compared to conventional techniques for generating, revising, and/or executing troubleshooting guide(s). For instance, the example techniques may be capable of reducing a number of manual operations that are performed by an engineer to generate, revise, or execute a troubleshooting guide. The example techniques may eliminate a need for such manual operations. By reducing the number of manual operations that are performed by the engineer, the example techniques may increase productivity of the engineer and reduce a cost associated with generating, revising, or executing the troubleshooting guide. For example, the cost associated with manual operations that are rendered unnecessary by the example techniques may be eliminated. The example techniques may increase productivity and efficiency of users who use the troubleshooting guide, reduce a cost of performing operations using the troubleshooting guide, reduce a likelihood that code and/or an API associated with the troubleshooting guide will experience an outage, and/or enable deployment of the code and/or utilization of the API to be scaled in a production environment. The example techniques may enable users with less experience in troubleshooting to use troubleshooting guides.

By automatically generating troubleshooting guides or automatically revising the troubleshooting guides, the example techniques may also standardize a structure of the troubleshooting guides and measure (e.g., automatically measure) the quality of the troubleshooting guides. The example techniques may provide (e.g., automatically provide) usage insights regarding how the troubleshooting guides are being used and issues that are encountered with regard to the troubleshooting guides. For instance, the example techniques may determine that readability of a troubleshooting guide falls below a standard, the troubleshooting guide is incomplete, the language in the troubleshooting guide is not thorough and/or is non-specific, and/or the troubleshooting guide does not include contact information of a person or a group of persons to be contacted for assistance with the troubleshooting guide.

The example techniques may increase security of a troubleshooting guide and the code and/or the API associated with the troubleshooting guide. For instance, the example techniques may reduce a need for an engineer to manually create a troubleshooting guide or to make an ad hoc change to the troubleshooting guide in an effort to increase the quality of the troubleshooting guide. By reducing the need for the engineer to manually create the troubleshooting guide or to make the ad hoc change, negative impacts of the manual creation or the ad hoc change on the optimization, safety, and/or security of the troubleshooting guide may be avoided. By automating generation and/or revision of the troubleshooting guide (e.g., thereby increasing the quality of the troubleshooting guide), the example techniques may reduce a likelihood that a user who uses the troubleshooting guide will perform an operation that damages the code and/or the API (e.g., compromises security or functionality of the code and/or the API). Accordingly, the example techniques may increase security of a computing system that executes the code and/or that utilizes the API.

By automating generation and/or revision of the troubleshooting guide to increase the quality of the troubleshooting guide, the example techniques may improve (e.g., increase) a user experience of a user who uses the troubleshooting guide, increase efficiency of the user, and/or reduce a cost associated with the user using the troubleshooting guide to perform operations regarding (e.g., on) the code and/or the API. Examples of an operation include diagnosing issue(s) (e.g., by retrieving logs from sources), resolving issue(s) (e.g., by restarting or patching the service), and removing issue(s) (e.g., by deleting a portion of the code and/or the API). The example techniques may be more efficient, reliable, and/or effective than conventional techniques for generating, revising, and/or executing a troubleshooting guide, for example, by increasing thoroughness and/or accuracy of the troubleshooting guide.

The example techniques may reduce an amount of time and/or resources (e.g., processor cycles, memory, network bandwidth) that is consumed to generate a troubleshooting guide, revise the troubleshooting guide, and/or use the troubleshooting guide to perform operations regarding the code and/or the API. For instance, by increasing the quality of the troubleshooting guide, a computing system may conserve the time and resources that would have been consumed by the computing system to execute instructions initiated by a user to figure out which operations are to be performed with regard to the code and/or the API and/or to execute instructions to remedy the effects of undesirable operations being performed as a result of the troubleshooting guide not being sufficiently thorough.

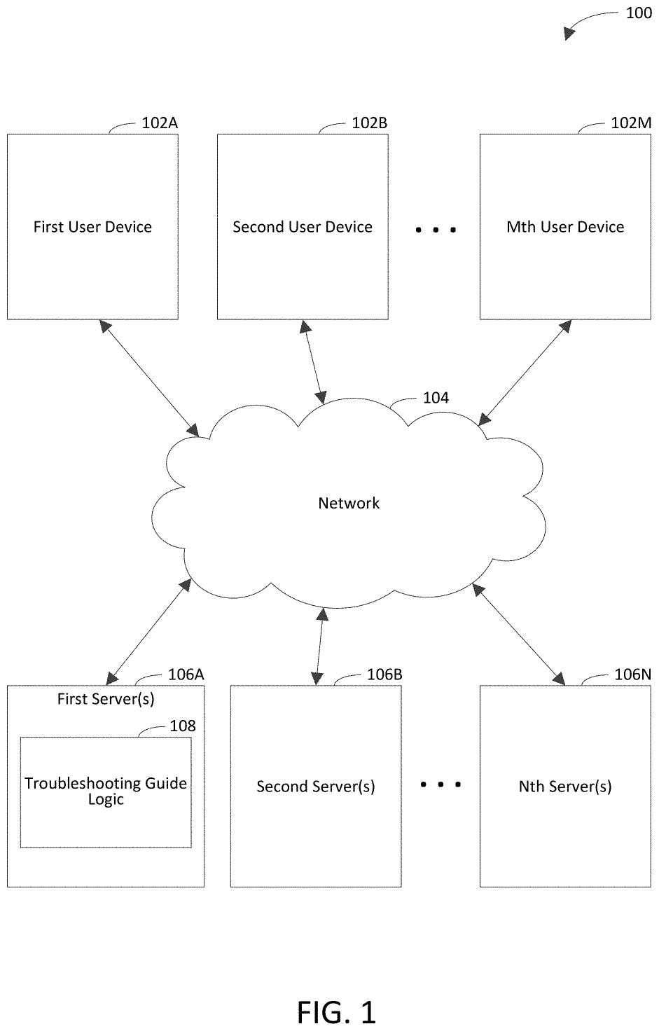

FIG. 1 is a block diagram of an example troubleshooting guide system 100 in accordance with an embodiment. Generally speaking, the troubleshooting guide system 100 operates to provide information to users in response to requests (e.g., hypertext transfer protocol (HTTP) requests) that are received from the users. The information may include documents (e.g., Web pages, images, audio files, and video files), output of executables, and/or any other suitable type of information. In accordance with example embodiments described herein, the troubleshooting guide system 100 automatically generates, revises, and/or executes troubleshooting guide(s). Detail regarding techniques for automatically generating, revising, and/or executing troubleshooting guide(s) is provided in the following discussion.

As shown in FIG. 1, the troubleshooting guide system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are processing systems that are capable of communicating with servers 106A-106N. An example of a processing system is a system that includes at least one processor that is capable of manipulating data in accordance with a set of instructions. For instance, a processing system may be a computer or a personal digital assistant. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are processing systems that are capable of communicating with the user devices 102A-102M. The servers 106A-106N are configured to execute computer programs that provide information to users in response to receiving requests from the users. For example, the information may include documents (e.g., Web pages, images, audio files, and video files), output of executables, or any other suitable type of information. In accordance with some example embodiments, the servers 106A-106N are configured to host respective Web sites, so that the Web sites are accessible to users of the troubleshooting guide system 100.

One example type of computer program that may be executed by one or more of the servers 106A-106N is a developer tool. A developer tool is a computer program that performs diagnostic operations (e.g., identifying the source of a problem, debugging, profiling, and controlling) with respect to program code and/or an API. Examples of a developer tool include a web development platform (e.g., Windows Azure Platform®, Amazon Web Services®, Google App Engine®, VMWare®, and Force.com®) and an integrated development environment (e.g., Microsoft Visual Studio®, JDeveloper®, NetBeans®, and Eclipse Platform™). It will be recognized that the example techniques described herein may be implemented using a developer tool.

The first server(s) 106A are shown to include troubleshooting guide logic 108 for illustrative purposes. The troubleshooting guide logic 108 is configured to automatically generate, revise, and/or execute troubleshooting guide(s). In a first example implementation, the troubleshooting guide logic 108 automatically generates an executable troubleshooting guide by determining a schema. The schema defines at least a subset of operations that are capable of being performed with regard to a service. The troubleshooting guide logic 108 selects a mitigation operation from the operations defined by the schema based at least in part on historical information, which indicates historical operations that have been performed previously to mitigate issues associated with the service, indicating that the mitigation operation is capable of mitigating a category of issues. The troubleshooting guide logic 108 automatically generates the executable troubleshooting guide, which is configured to perform the mitigation operation, as a result of selecting the mitigation operation from the operations.

In a second example implementation, the troubleshooting guide logic 108 automatically generates an executable troubleshooting guide by identifying an issue that occurs with regard to a service. The troubleshooting guide logic 108 analyzes historical information to identify historical operations that have been performed previously with regard to one or more services to mitigate issues associated with the one or more services. The troubleshooting guide logic 108 selects a mitigation operation from the historical operations based at least in part on the historical information indicating that the mitigation operation is capable of mitigating a category of issues that includes the issue. The troubleshooting guide logic 108 automatically generates the executable troubleshooting guide, which is configured to perform the mitigation operation, as a result of selecting the mitigation operation from the historical operations.

In a third example implementation, the troubleshooting guide logic 108 automatically revises at least one troubleshooting guide by extracting features from data associated with troubleshooting guide(s) that are associated with code and/or an application programming interface (API). Each troubleshooting guide includes instructions that describe operations to be performed to resolve issues associated with the code and/or the API. Each feature indicates an attribute of at least one of the troubleshooting guide(s). Example attributes of a troubleshooting guide include a positive or negative rating or comment from a user of the troubleshooting guide, a number of times the troubleshooting guide is viewed, an amount of time (e.g., average time) that users of the troubleshooting guide dwell on the troubleshooting guide (i.e., the time frame in which a user stays on the troubleshooting guide page), an extent (e.g., average extent) to which users of the troubleshooting guide scroll within the troubleshooting guide, an amount of time that is consumed to resolve an issue that a user uses the troubleshooting guide to resolve, and a number of users (e.g., daily active users or monthly active users) of the troubleshooting guide, usability (e.g., readability) of the troubleshooting guide, completeness of the troubleshooting guide, correctness of the troubleshooting guide, whether the troubleshooting guide is nested in another document, whether the troubleshooting guide includes a nested document, ambiguity of the troubleshooting guide (e.g., an extent of subjective information that is included in the troubleshooting guide), an amount of time since the troubleshooting guide was created, an amount of time since the troubleshooting guide was most recently updated, whether the troubleshooting guide is empty, a length of the troubleshooting guide, whether the troubleshooting guide includes contact information of an entity that provides support to users of the troubleshooting guide, a number of commands that are included in the troubleshooting guide, whether the troubleshooting guide includes executable code or a pointer to executable code, a number of links that are included in the troubleshooting guide, whether the troubleshooting guide includes nested lists, a number of tables that are include in the troubleshooting guide, and a number of acronyms that are included in the troubleshooting guide. The troubleshooting guide logic 108 assigns weights to the respective features. The troubleshooting guide logic 108 automatically revises a subset of the troubleshooting guide(s) based at least in part on the weights assigned to the respective features that correspond to the subset of the troubleshooting guide(s) to increase quality of each troubleshooting guide in the subset.

The troubleshooting guide logic 108 may use machine learning (ML) to perform at least some of its operations. For instance, the troubleshooting guide logic 108 may use the ML to develop and/or refine an understanding of the historical information to identify the historical operations that have been performed previously to mitigate issues and/or to develop and/or refine the features that are extracted from the data associated with the troubleshooting guide(s).

For example, the troubleshooting guide logic 108 may use the ML to analyze the historical information to identify historical operations that have been performed previously with regard to service(s), issues associated with the service(s), and mitigations of those issues and to determine relationships between the historical operations, the issues, and the mitigations.

In another example, the troubleshooting guide logic 108 may use the ML to analyze the data to identify attribute(s) of each troubleshooting guide, to determine which attributes are shared by which troubleshooting guides, to derive the features from respective subsets of the attributes, and to identify the troubleshooting guide(s) associated with each feature based on each of those troubleshooting guide(s) having at least one attribute that is included in the subset from which the respective feature is derived.

The troubleshooting guide logic 108 may use a neural network to perform the ML to predict operations that are capable of mitigating issues and to predict values of respective attributes of troubleshooting guide(s). The troubleshooting guide logic 108 may use at least one of the operations to automatically generate a troubleshooting guide and/or may use the attributes to predict values of features that are used to automatically revise a troubleshooting guide. For example, attributes of troubleshooting guides may be analyzed to determine similarities between the attributes, and the values of the features may be predicted based on the similarities. The troubleshooting guide may be revised based on shortcomings of the troubleshooting guide that are revealed by the values of the features. Examples of a neural network include a feed forward neural network and a long short-term memory (LSTM) neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the troubleshooting guide logic 108 employs a feed forward neural network to train a ML model that is used to determine ML-based confidences. Such ML-based confidences may be used to determine likelihoods that events will occur.

An LSTM neural network is a recurrent neural network that has memory and allows data to flow forward and backward in the neural network. The LSTM neural network is capable of remembering values for short time periods or long time periods. Accordingly, the LSTM neural network may keep stored values from being iteratively diluted over time. In one example, the LSTM neural network may be capable of storing information, such as historical mitigating operations, historical values of respective attributes of troubleshooting guides, and/or historical values of respective features over time. For instance, the LSTM neural network may generate a mitigation operation model, an attribute model, and/or a feature model by utilizing such information. In another example, the LSTM neural network may be capable of remembering relationships (e.g., relationships between historical operations, issues, mitigations, attributes, and/or features) and ML-based confidences that are derived therefrom.

The troubleshooting guide logic 108 may include training logic and inference logic. The training logic is configured to train a ML algorithm that the inference logic uses to determine (e.g., infer) the ML-based confidences. For instance, the training logic may provide sample operations, sample issues, sample mitigations, sample attributes, sample features, sample probabilities that respective operations correspond to each issue, sample probabilities that respective operations mitigate each issue or facilitate mitigation of each issue, sample probabilities that respective attributes correspond to each feature, and sample confidences as inputs to the algorithm to train the algorithm. The sample data may be labeled. The ML algorithm may be configured to derive relationships between the operations and the issues, between the operations and the mitigations, and between the attributes and/or features and the resulting ML-based confidences. The inference logic is configured to utilize the ML algorithm, which is trained by the training logic, to determine the ML-based confidence when the historical information and/or the data associated with the troubleshooting guide(s) is provided as input to the algorithm.

The troubleshooting guide logic 108 may be implemented in various ways to automatically generate, revise, and/or execute troubleshooting guide(s), including being implemented in hardware, software, firmware, or any combination thereof. For example, the troubleshooting guide logic 108 may be implemented as computer program code configured to be executed in a processing system (e.g., one or more processors). In another example, at least a portion of the troubleshooting guide logic 108 may be implemented as hardware logic/electrical circuitry. For instance, at least a portion of the troubleshooting guide logic 108 may be implemented in a field-programmable gate array (FPGA), an application-specific integrated circuit (ASIC), an application-specific standard product (ASSP), a system-on-a-chip system (SoC), or a complex programmable logic device (CPLD). Each SoC may include an integrated circuit chip that includes one or more of a processor (e.g., a microcontroller, microprocessor, or digital signal processor (DSP)), memory, one or more communication interfaces, and/or further circuits and/or embedded firmware to perform its functions.

The troubleshooting guide logic 108 may be partially or entirely incorporated in a developer tool, such as a web development platform or an integrated development environment, though the example embodiments are not limited in this respect.

The troubleshooting guide logic 108 is shown to be incorporated in the first server(s) 106A for illustrative purposes and is not intended to be limiting. It will be recognized that the troubleshooting guide logic 108 (or any portion(s) thereof) may be incorporated in any one or more of the user devices 102A-102M. For example, client-side aspects of the troubleshooting guide logic 108 may be incorporated in one or more of the user devices 102A-102M, and server-side aspects of troubleshooting guide logic 108 may be incorporated in the first server(s) 106A. In another example, the troubleshooting guide logic 108 may be distributed among the user devices 102A-102M. In yet another example, the troubleshooting guide logic 108 may be incorporated in a single one of the user devices 102A-102M. In another example, the troubleshooting guide logic 108 may be distributed among the server(s) 106A-106N. In still another example, the troubleshooting guide logic 108 may be incorporated in a single one of the servers 106A-106N.

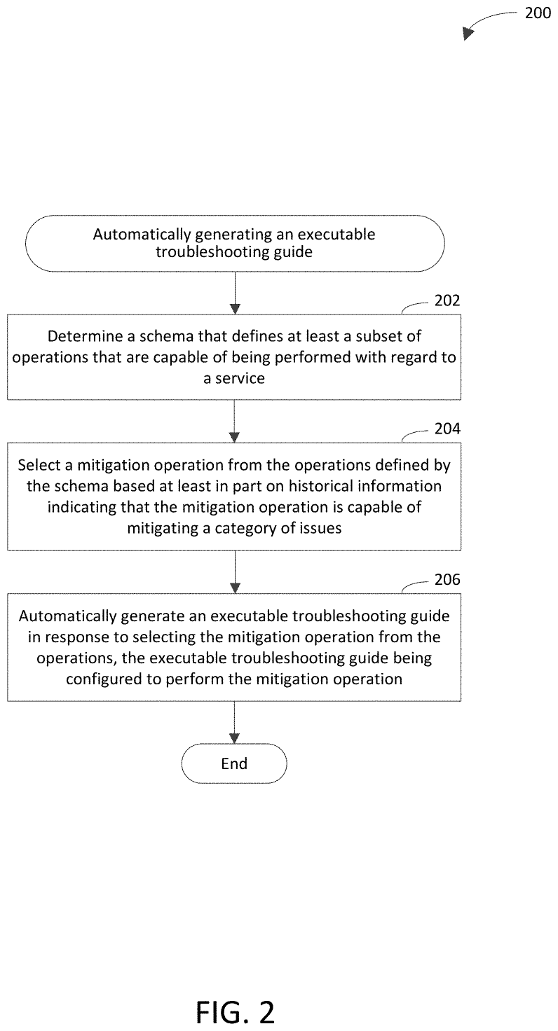

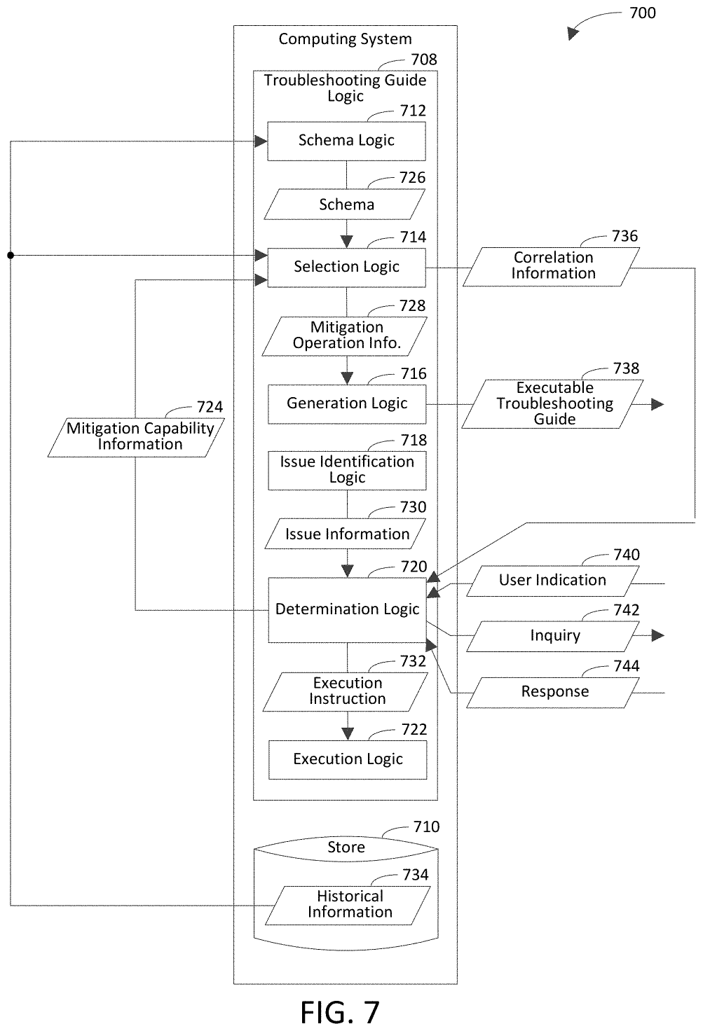

FIGS. 2-6 depict flowcharts 200, 300, 400, 500, and 600 of example methods for automatically generating an executable troubleshooting guide in accordance with embodiments. Flowcharts 200, 300, 400, 500, and 600 may be performed by the first server(s) 106A, shown in FIG. 1, for example. For illustrative purposes, flowcharts 200, 300, 400, 500, and 600 are described with respect to computing system 700 shown in FIG. 7, which is an example implementation of the first server(s) 106A. As shown in FIG. 7, the computing system 700 includes troubleshooting guide logic 708 and a store 710. The troubleshooting guide logic 708 includes schema logic 712, selection logic 714, generation logic 716, issue identification logic 718, determination logic 720, and execution logic 722. The store 710 may be any suitable type of store. One suitable type of store is a database. For instance, the store 710 may be a relational database, an entity-relationship database, an object database, an object relational database, or an extensible markup language (XML) database. The store 710 is shown to store historical information 734 for illustrative purposes. Further structural and operational embodiments will be apparent to persons skilled in the relevant art(s) based on the discussion regarding flowcharts 200, 300, 400, 500, and 600.

As shown in FIG. 2, the method of flowchart 200 begins at step 202. In step 202, a schema is determined. The schema defines at least a subset of operations that are capable of being performed with regard to (e.g., on) a service. In an example, the schema may be automatically created. In another example, the schema may be created based on instructions that are received from a user (e.g., developer, support engineer, or end user) who provides the instructions manually (e.g., via an editor). In an example implementation, the schema logic 712 determines a schema 726, which defines the operations.

In an example embodiment, determining the schema at step 202 is performed based at least in part on the operations that have been performed previously to mitigate issues associated with the service, as indicated by the historical information.

In another example embodiment, determining the schema at step 202 is performed based at least in part on the operations that are capable of being performed with regard to the service being identified in a document associated with (e.g., generated by) a user of the service or in instructions associated with the user of the service.

At step 204, a mitigation operation is selected (e.g., automatically selected) from the operations defined by the schema based at least in part on historical information, which indicates historical operations that have been performed previously to mitigate issues associated with the service, indicating that the mitigation operation is capable of mitigating a category of issues. For instance, the mitigation operation may be configured to diagnose any one or more of the issues (e.g., by retrieving logs from sources), resolving any one or more of the issues (e.g., by restarting or patching the service), or removing any one or more of the issues.

In an example implementation, the selection logic 714 selects the mitigation operation from the operations defined by the schema 726 based at least in part on historical information 734, which indicates the historical operations, indicating that the mitigation operation is capable of mitigating the category of issues. The selection logic 714 may retrieve the historical information 734 from the store 710 and analyze the historical information 734 to determine that the mitigation operation is capable of mitigating the category of issues. For example, by analyzing the historical information 734, the selection logic 714 may identify a correlation between the mitigation operation and mitigation of each issue in the category of issues. The selection logic 714 may determine that the mitigation operation is capable of mitigating the category of issues based on (e.g., based at least in part on) confidences associated with the correlations between the mitigation operation and the mitigation of the issues in the category of issues being greater than or equal to a confidence threshold. The selection logic 714 may generate mitigation operation information 728 to indicate (e.g., identify and/or describe) the mitigation operation. The selection logic 714 may generate correlation information 736 to indicate the correlation between the mitigation operation and the mitigation of at least a subset of the category of issues (e.g., each issue in the category of issues) and/or to indicate the confidences associated with the correlations.

At step 206, an executable troubleshooting guide that is configured to perform the mitigation operation is automatically generated (e.g., automatically created) as a result of selecting the mitigation operation from the operations. In an example implementation, the generation logic 716 automatically generates an executable troubleshooting guide 738, which is configured to perform the mitigation operation. For instance, the generation logic 716 may automatically generate the executable troubleshooting guide 738 based on the mitigation operation information 728 indicating the mitigation operation.

In some example embodiments, one or more steps 202, 204, and/or 206 of flowchart 200 may not be performed. Moreover, steps in addition to or in lieu of steps 202, 204, and/or 206 may be performed. For instance, in an example embodiment, the method of flowchart 200 further includes determining that an issue has occurred with regard to the service. In an example implementation, the issue identification logic 718 determines that the issue has occurred with regard to the service. For instance, the issue identification logic 718 may analyze logs that are received from sources associated with the service to identify the issue. The issue identification logic 718 may generate issue information 730, which indicates (e.g., identifies and/or describes) the issue. In accordance with this embodiment, the method of flowchart 200 further includes determining that the mitigation operation is capable of mitigating the issue based at least in part on the issue being included in the category of issues that the mitigation operation is capable of mitigating. In an example implementation, the determination logic 720 determines that the mitigation operation is capable of mitigating the issue. For instance, the determination logic 720 may analyze the correlation information 736 to determine that the mitigation operation is capable of mitigating the issue. For example, by analyzing the correlation information 736, the determination logic 720 may determine that the mitigation operation is capable of mitigating the category of issues, and the determination logic 720 may cross-reference the issue with the issues in the category, as indicated by the correlation information 736, to determine that the mitigation operation is capable of mitigating the issue. In further accordance with this embodiment, selecting the mitigation operation at step 204 is performed based at least in part on determining that the mitigation operation is capable of mitigating the issue.

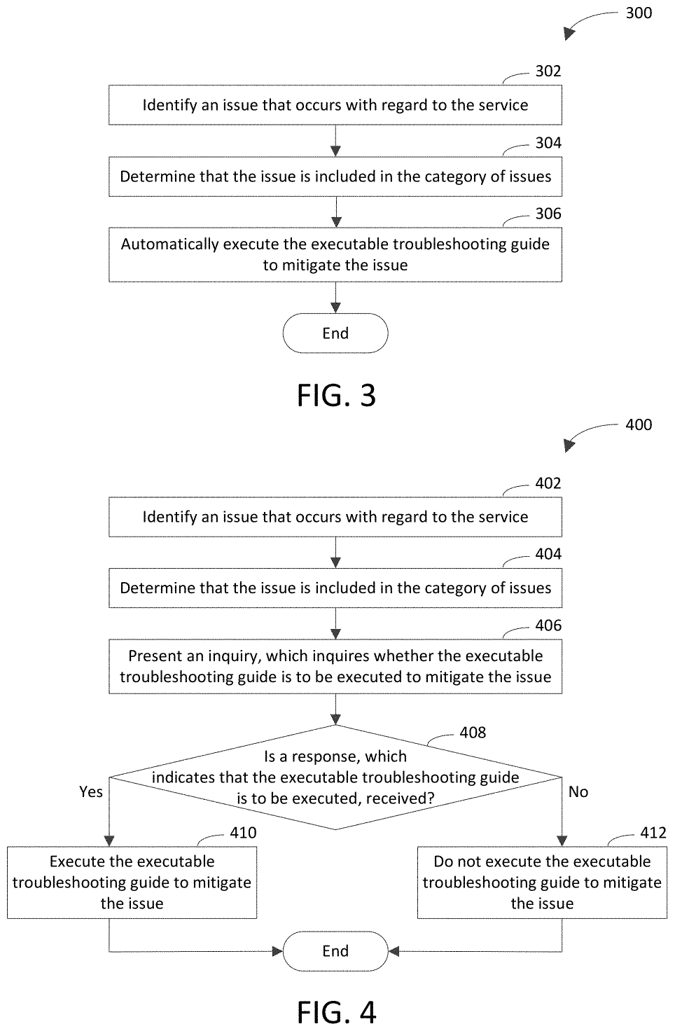

In another example embodiment, the method of flowchart 200 further includes one or more of the steps shown in flowchart 300 of FIG. 3. As shown in FIG. 3, the method of flowchart 300 begins at step 302. In step 302, an issue that occurs with regard to the service is identified. For instance, the issue identification logic 718 may identify the issue. The issue identification logic 718 may generate the issue information 730 to indicate the issue.

At step 304, a determination is made that the issue is included in the category of issues. For example, the determination logic 720 may determine that the issue is included in the category of issues. In accordance with this example, the determination logic 720 may analyze the correlation information 736 to identify the issues in the category of issues. The determination logic 720 may cross-reference the issue, as indicated by the issue information 730, with the issues in the category of issues, as indicated by the correlation information 736, to determine that the issue is included in the category of issues. The determination logic 720 may generate an execution instruction 732 based on determining that the issue is included in the category of issues. The execution instruction 732 may instruct the execution logic 722 to execute the executable troubleshooting guide.

At step 306, the executable troubleshooting guide is automatically executed to mitigate the issue based at least in part on determining that the issue is included in the category of issues. For instance, the execution logic 722 may automatically execute the executable troubleshooting guide. In accordance with this example, the execution logic 722 may automatically execute the executable troubleshooting guide based on receipt of the execution instruction 732 (e.g., based on the execution instruction 732 instructing the execution logic 722 to execute the executable troubleshooting guide).

In yet another example embodiment, the method of flowchart 200 further includes one or more of the steps shown in flowchart 400 of FIG. 4. As shown in FIG. 4, the method of flowchart 400 begins at step 402. In step 402, an issue that occurs with regard to the service is identified. For instance, the issue identification logic 718 may identify the issue. The issue identification logic 718 may generate the issue information 730 to indicate the issue.

At step 404, a determination is made that the issue is included in the category of issues. For example, the determination logic 720 may determine that the issue is included in the category of issues. In accordance with this example, the determination logic 720 may cross-reference the issue, as indicated by the issue information 730, with the issues in the category of issues, as indicated by the correlation information 736, to determining that the issue is included in the category of issues.

At step 406, an inquiry, which inquires whether the executable troubleshooting guide is to be executed to mitigate the issue, is presented based at least in part on determining that the issue is included in the category of issues. For instance, the determination logic 720 may present an inquiry 742, which inquires whether the executable troubleshooting guide is to be executed to mitigate the issue.

At step 408, a determination is made whether a response, which indicates that the executable troubleshooting guide is to be executed, is received in response to the inquiry. If the response is received, flow continues to step 410. Otherwise, flow continues to step 412. For instance, the determination logic 720 may determine whether a response 744, which indicates that the executable troubleshooting guide is to be executed, is received in response to the inquiry 742. The determination logic 720 may be configured to generate the execution instruction 732 based on receipt of the response 744. The determination logic 720 may be configured to not generate the execution instruction 732 based on the response 744 not being received.

At step 410, the executable troubleshooting guide is executed to mitigate the issue. For example, the execution logic 722 may execute the executable troubleshooting guide. Upon completion of step 410, flowchart 400 ends.

At step 412, the executable troubleshooting guide is not executed to mitigate the issue. For instance, the execution logic 722 may not execute the executable troubleshooting guide. Upon completion of step 412, flowchart 400 ends.

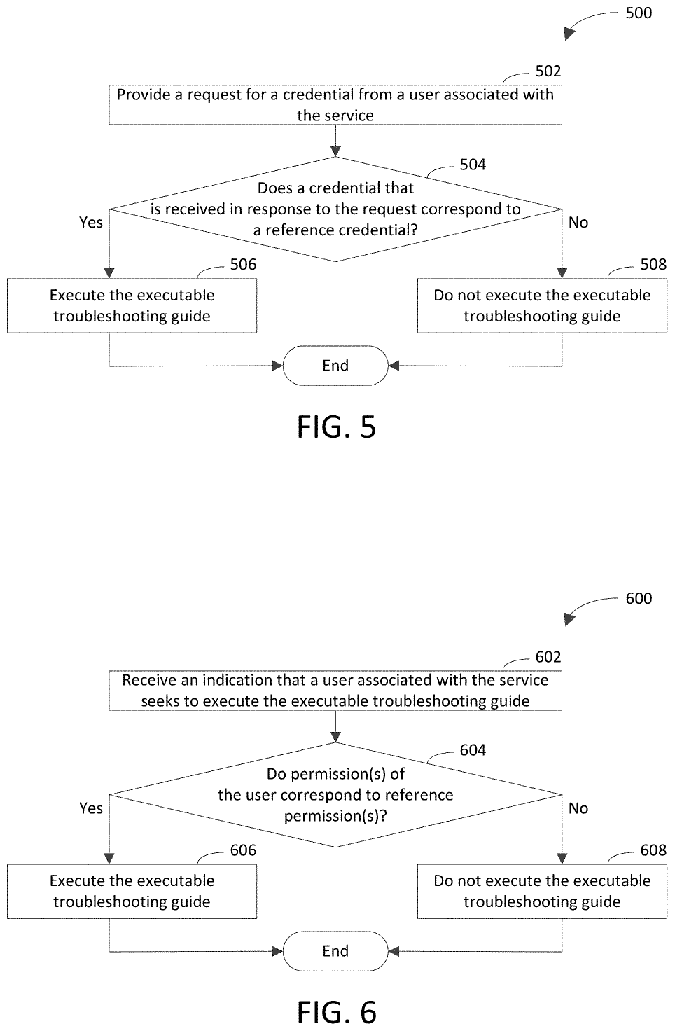

In still another example embodiment, the executable troubleshooting guide automatically generated at step 206 is conditionally executable such that authentication is a prerequisite for execution of the troubleshooting guide. In accordance with this embodiment, the method of flowchart 200 further includes one or more of the steps shown in flowchart 500 of FIG. 5. As shown in FIG. 5, the method of flowchart 500 begins at step 502. In step 502, a request, which requests a credential from a user associated with the service, is provided. For example, the determination logic 720 provides the request. In accordance with this example, the determination logic 720 may generate the inquiry 742 to include the request.

At step 504, a determination is made whether a credential received in response to the request corresponds to (e.g., matches) a reference credential. Examples of a credential include a username, a password, a personal identification number (PIN), information from a hardware token or a FIDO token, an authenticator push notification from a computing device associated with the user, and a transaction authentication number (TAN). In an example, a determination that the credential corresponds to the reference credential may indicate that the user is authenticated. In accordance with this example, a determination that the credential does not correspond to the reference credential may indicate that the user is not authenticated.

For example, the determination logic 720 may determine whether the credential corresponds to the reference credential. In accordance with this example, the determination logic 720 may receive the response 744, including the credential, to the request. The determination logic 720 may analyze the response 744 to identify the credential. The determination logic 720 may compare the credential and the reference credential to determine whether the credential corresponds to the reference credential. The determination logic 720 may be configured to generate the execution instruction 732, instructing the execution logic 722 to execute the executable troubleshooting guide, based on a determination that the credential corresponds to the reference credential. The determination logic 720 may be configured to not generate the execution instruction 732 based on a determination that the credential does not correspond to the reference credential. If the credential corresponds to the reference credential, flow continues to step 506. Otherwise, flow continues to step 508.

At step 506, the executable troubleshooting guide is executed (e.g., as a result of the user being authenticated). For example, the execution logic 722 may execute the executable troubleshooting guide (e.g., based on receipt of the execution instruction 732). Upon completion of step 506, flowchart 500 ends.

At step 508, the executable troubleshooting guide is not executed (e.g., as a result of the user not being authenticated). For instance, the execution logic 722 may not execute the executable troubleshooting guide (e.g., based on the execution instruction 732 not being received). Upon completion of step 508, flowchart 500 ends.

In another example embodiment, the method of flowchart 200 further includes one or more of the steps shown in flowchart 600 of FIG. 6. As shown in FIG. 6, the method of flowchart 600 begins at step 602. In step 602, the method of flowchart 200 further includes receiving an indication that a user associated with the service seeks to execute the executable troubleshooting guide. For example, the determination logic 720 may receive a user indication 740, which indicates that the user seeks to execute the executable troubleshooting guide.

At step 604, a determination is made whether permission(s) of the user correspond to reference permission(s). If the permission(s) of the user correspond to the reference permission(s), flow continues to step 606. Otherwise, flow continues to step 608. For instance, the determination logic 720 may determine whether the permission(s) of the user correspond to the reference permission(s). The determination logic 720 may be configured to generate the execution instruction 732 based on the permission(s) of the user corresponding to the reference permission(s). The determination logic 720 may be configured to not generate the execution instruction 732 based on the permission(s) of the user not corresponding to the reference permission(s).

At step 606, the executable troubleshooting guide is executed. For example, the execution logic 722 may execute the executable troubleshooting guide (e.g., based on receipt of the execution instruction 732). Upon completion of step 606, flowchart 600 ends.

At step 608, the executable troubleshooting guide is not executed. For instance, the execution logic 722 may not execute the executable troubleshooting guide (e.g., based on the execution instruction 732 not being received). Upon completion of step 608, flowchart 600 ends.

It will be recognized that the computing system 700 may not include one or more of the troubleshooting guide logic 708, the store 710, the schema logic 712, the selection logic 714, the generation logic 716, the issue identification logic 718, the determination logic 720, and/or the execution logic 722. Furthermore, the computing system 700 may include components in addition to or in lieu of the troubleshooting guide logic 708, the store 710, the schema logic 712, the selection logic 714, the generation logic 716, the issue identification logic 718, the determination logic 720, and/or the execution logic 722.

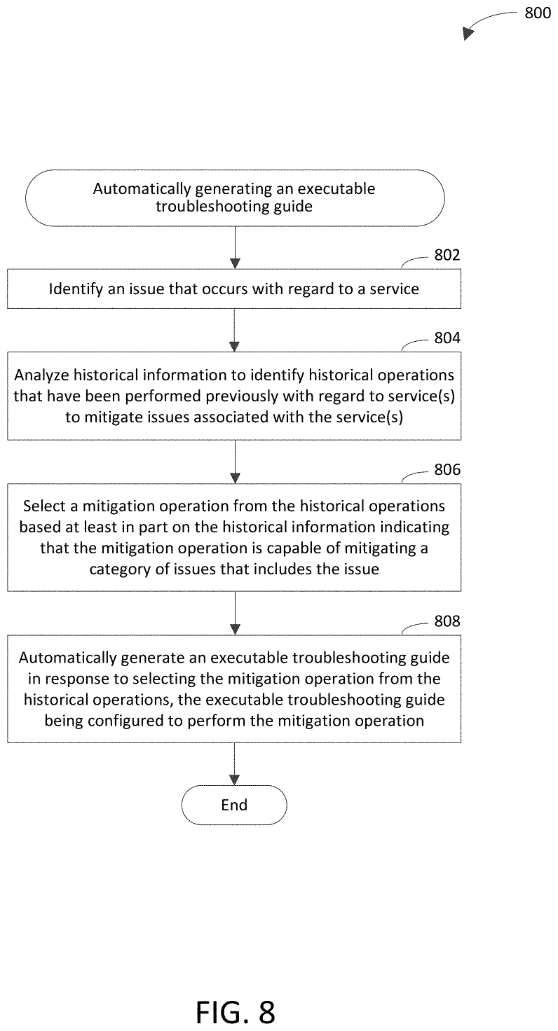

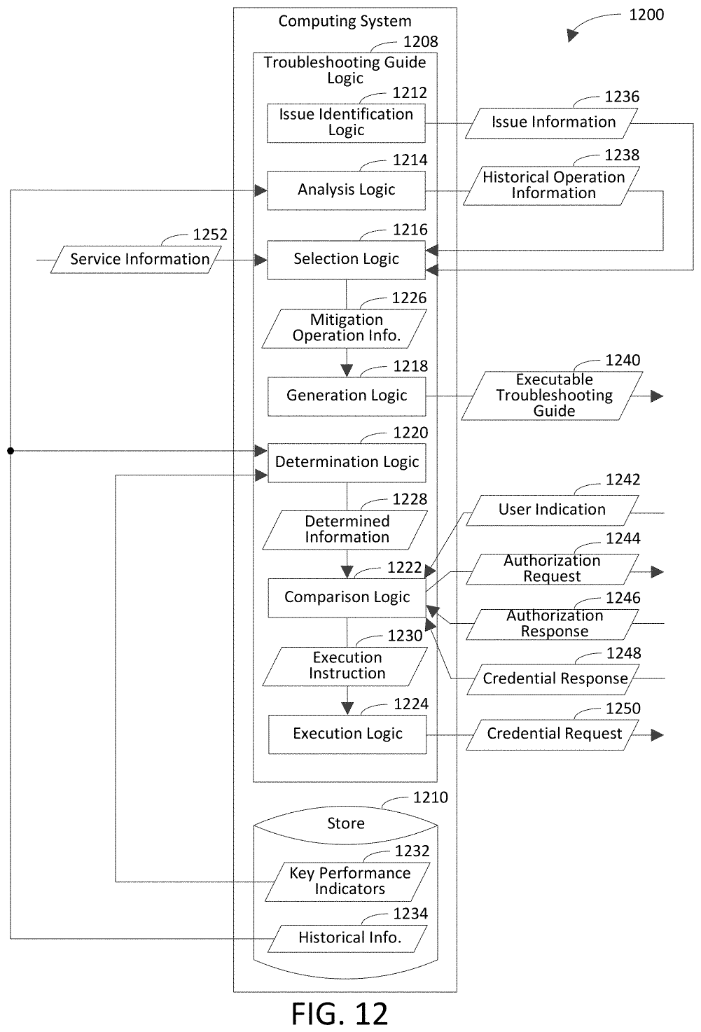

FIGS. 8-11 depict flowcharts 800, 900, 1000, and 1100 of example methods for automatically generating an executable troubleshooting guide in accordance with embodiments. Flowcharts 800, 900, 1000, and 1100 may be performed by the first server(s) 106A, shown in FIG. 1, for example. For illustrative purposes, flowcharts 800, 900, 1000, and 1100 are described with respect to computing system 1200 shown in FIG. 12, which is an example implementation of the first server(s) 106A. As shown in FIG. 12, the computing system 1200 includes troubleshooting guide logic 1208 and a store 1210. The troubleshooting guide logic 1208 includes issue identification logic 1212, analysis logic 1214, selection logic 1216, generation logic 1218, determination logic 1220, comparison logic 1222, and execution logic 1224. The store 1210 may be any suitable type of store. One suitable type of store is a database. For instance, the store 1210 may be a relational database, an entity-relationship database, an object database, an object relational database, or an extensible markup language (XML) database. The store 1210 is shown to store key performance indicators 1232 and historical information 1234 for illustrative purposes. Further structural and operational embodiments will be apparent to persons skilled in the relevant art(s) based on the discussion regarding flowcharts 800, 900, 1000, and 1100.

As shown in FIG. 8, the method of flowchart 800 begins at step 802. In step 802, an issue that occurs with regard to a service is identified. In an example implementation, the issue identification logic 1212 identifies the issue. The issue identification logic 1212 may generate issue information 1236, which indicates (e.g., identifies and/or describes) the issue that occurs with regard to the service.

At step 804, historical information is analyzed to identify historical operations that have been performed previously with regard to service(s) to mitigate issues associated with the service(s). In an example implementation, analysis logic 1214 analyzes historical information 1234 to identify the historical operations that have been performed previously with regard to the service(s). For instance, the analysis logic 1214 may retrieve the historical information 1234 from the store 1210 to identify the historical operations indicated in the historical information 1234. The analysis logic 1214 may generate historical operation information 1238, which indicates the historical operations that have been performed previously with regard to the service(s) to mitigate the issues associated with the service(s). The historical operation information 1238 may further indicate which of the operations were successful in mitigating the issues for which those operations were performed and which of the operations were not successful in mitigating the issues for which those operations were performed.

At step 806, a mitigation operation is selected from the historical operations based at least in part on the historical information indicating that the mitigation operation is capable of mitigating a category of issues that includes the issue. In an example implementation, the selection logic 1216 selects the mitigation operation from the historical operations based at least in part on the historical information 1234 indicating that the mitigation operation is capable of mitigating a category of issues that includes the issue. For instance, the selection logic 1216 may analyze the historical operation information 1238 to identify categories of issues. The selection logic 1216 may cross-reference the issue that occurs with regard to the service, as indicated in the issue information 1236, and the categories of issues that are indicated by the historical operation information 1238 to determine a category of issues that includes the issue that is indicated by the issue information 1236. By analyzing the historical operation information 1238, the selection logic 1216 may identify correlations between the historical operations that have been performed for the issues in the category of issues and mitigations of those issues. The selection logic 1216 may determine that the mitigation operation is capable of mitigating the category of issues based on (e.g., based at least in part on) confidences associated with the correlations between the mitigation operation and the mitigations of the issues in the category of issues being greater than or equal to a confidence threshold. The selection logic 1216 may generate mitigation operation information 1226 to indicate (e.g., identify and/or describe) the mitigation operation. The mitigation operation information 1226 may indicate the correlation between the mitigation operation and the mitigation of at least a subset of the category of issues (e.g., each issue in the category of issues), may indicate the confidences associated with the correlations, and/or may indicate that the mitigation operation is capable of mitigating the category of issues.

At step 808, an executable troubleshooting guide is automatically generated as a result of selecting the mitigation operation from the historical operations. The executable troubleshooting guide is configured to perform the mitigation operation. In an example implementation, the generation logic 1218 automatically generates an executable troubleshooting guide 1240, which is configured to perform the mitigation operation. For instance, the generation logic 1218 may automatically generate the executable troubleshooting guide 1240 based on receipt of the mitigation operation information 1226 (e.g., based on the mitigation operation information 1226 indicating the mitigation operation).

In some example embodiments, one or more steps 802, 804, 806, and/or 808 of flowchart 800 may not be performed. Moreover, steps in addition to or in lieu of steps 802, 804, 806, and/or 808 may be performed. For instance, in an example embodiment, the method of flowchart 800 further includes determining a subset of the service(s) such that each service in the subset and the service with regard to which the issue is identified have one or more characteristics in common. Examples of a characteristic include a type of service, a number of users of the service, a range of dates within which a service was created, and a range of dates within which a service was last updated. In an example, the selection logic 1216 may determine the subset of the service(s). In accordance with this example, the selection logic 1216 may analyze service information 1252 to determine attributes of each of the service(s) and attributes of the service with regard to which the issue is identified. The selection logic 1216 may compare the attributes of the service with regard to which the issue is identified and the attributes of each of the service(s) to determine which of the service(s) have at least one attribute (e.g., at least one specified attribute) in common with the service with regard to which the issue is identified. The selection logic 1216 may select each of the service(s) that has at least one attribute in common with the service with regard to which the issue is identified to be included in the subset. In accordance with this example, the mitigation operation is selected from the historical operations at step 808 based at least in part on the historical information (e.g., the historical operation information 1238, which is generated based on the historical information 1234) indicating that the mitigation operation has been performed with regard to at least one service in the subset.

In another example embodiment, the method of flowchart 800 further includes one or more of the steps shown in flowchart 500 of FIG. 5, which is described above. With regard to step 502, the execution logic 1224 may provide a credential request 1250, which requests the credential from the user associated with the service.

With regard to step 504, the comparison logic 1222 may receive a credential response 1248 from the user in response to the credential request 1250. The credential response 1248 includes a credential. The comparison logic 1222 may determine whether the credential, which is included in the credential response 1248, corresponds to the reference credential. The comparison logic 1222 may be configured to generate an execution instruction 1230, instructing the execution logic 1224 to execute the executable troubleshooting guide, based on a determination that the credential corresponds to the reference credential. The comparison logic 1222 may be configured to not generate the execution instruction 1230 based on a determination that the credential does not correspond to the reference credential.

With regard to step 506, the execution logic 1224 may execute the executable troubleshooting guide (e.g., based on receipt of the execution instruction 1230).

With regard to step 508, the execution logic 1224 may not execute the executable troubleshooting guide (e.g., based on the execution instruction 1230 not being received).

In yet another example embodiment, the method of flowchart 800 further includes one or more of the steps shown in flowchart 600 of FIG. 6, which is described above. With regard to step 602, the comparison logic 1222 may receive a user indication 1242, which indicates that the user seeks to execute the executable troubleshooting guide.

With regard to step 604, the comparison logic 1222 may determine whether the permission(s) of the user correspond to the reference permission(s). The comparison logic 1222 may be configured to generate the execution instruction 1230 based on the permission(s) of the user corresponding to the reference permission(s). The comparison logic 1222 may be configured to not generate the execution instruction 1230 based on the permission(s) of the user not corresponding to the reference permission(s).

With regard to step 606, the execution logic 1224 may execute the executable troubleshooting guide (e.g., based on receipt of the execution instruction 1230).

With regard to step 608, the execution logic 1224 may not execute the executable troubleshooting guide (e.g., based on the execution instruction 1230 not being received).

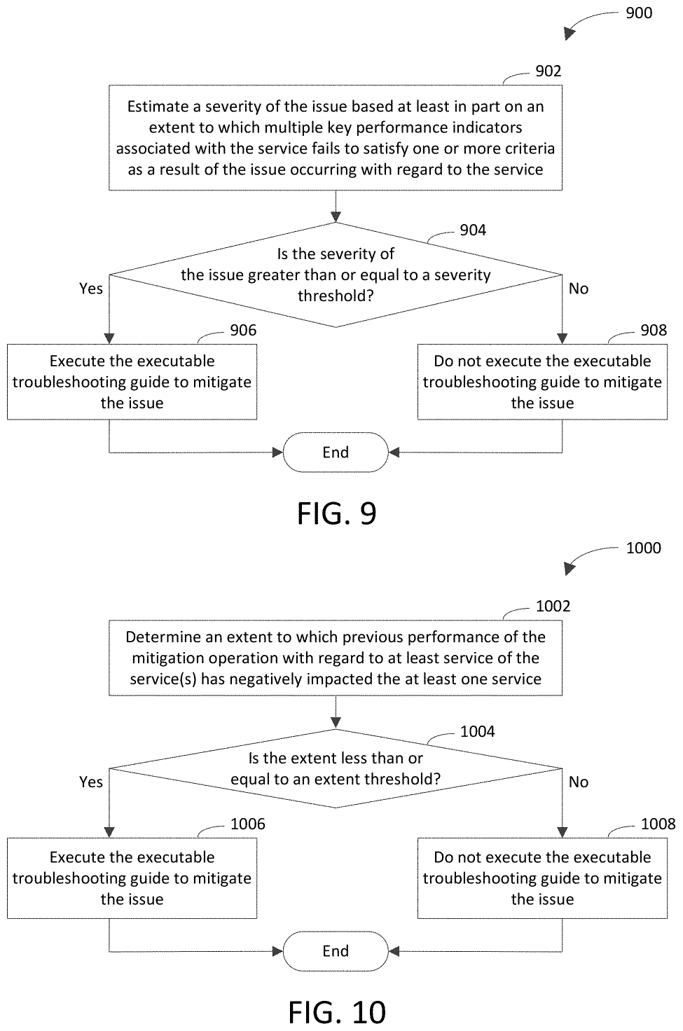

In still another example embodiment, the method of flowchart 800 further includes one or more of the steps shown in flowchart 900 of FIG. 9. As shown in FIG. 9, the method of flowchart 900 begins at step 902. In step 902, a severity of the issue is estimated based at least in part on an extent to which each of multiple key performance indicators (KPIs) associated with the service fails to satisfy one or more criteria as a result of the issue occurring with regard to the service. Each KPI specifies an attribute of the service. For example, a KPI may specify a number of customers affected (e.g., negatively affected) by the issue, and a criterion may require that the number of customers affected by the issue is less than or equal to a threshold number. In another example, a KPI may specify a proportion of the customers of the service who are affected by the issue, and a criterion may require that the proportion of the customers who are affected by the issue is less than or equal to a threshold proportion. In yet another example, a KPI may specify a number of alerts (e.g., security alerts, error alerts) issued by the service during a time period corresponding to the issue, and a criterion may require that the number of alerts is less than or equal to a threshold number. In still another example, a KPI may specify a response time of the service, and a criterion may require that the response time of the service is less than or equal to a threshold time. In another example, a KPI may specify that the service is down (e.g., inoperable), and a criterion may require that the service does not go down. In yet another example, a KPI may specify that a website that is associated with the service is not rendering, and a criterion may require that the website does not stop rendering.

In an example implementation, the determination logic 1220 estimates the severity of the issue based at least in part on an extent to which multiple key performance indicators (KPIs) 1232 associated with the service fail to satisfy one or more criteria as a result of the issue occurring with regard to the service. For instance, the determination logic 1220 may retrieve the KPIs 1232 from the store 1210 and analyze the KPIs 1232 to determine the extent to which each of the KPIs 1232 fails to satisfy one or more criteria as a result of the issue occurring with regard to the service. The determination logic 1220 may generate determined information 1228, which indicates the severity of the issue. The determined information 1228 may further indicate the extent to which each of the KPIs 1232 files to satisfy one or more criteria as a result of the issue occurring with regard to the service.

At step 904, a determination is made whether the severity of the issue is greater than or equal to a severity threshold. If the severity of the issue is greater than or equal to the severity threshold, flow continues to step 906. Otherwise, flow continues to step 908. In an example implementation, the comparison logic 1222 determines whether the severity of the issue is greater than or equal to the severity threshold. For instance, the comparison logic 1222 may compare the severity of the issue, as indicated by the determined information 1228, to the severity threshold to make the determination. The comparison logic 1222 may be configured to generate the execution instruction 1230, which instructs the execution logic 1224 to execute the executable troubleshooting guide, based on the severity of the issue being greater than or equal to the severity threshold. The comparison logic 1222 may be configured to not generate the execution instruction 1230 based on the severity of the issue being less than the severity threshold.

At step 906, the executable troubleshooting guide is executed to mitigate the issue. In an example implementation, the execution logic 1224 executes the executable troubleshooting guide (e.g., based on receipt of the execution instruction 1230).

At step 908, the executable troubleshooting guide is not executed to mitigate the issue. In an example implementation, the execution logic 1224 does not execute the executable troubleshooting guide (e.g., based on the execution instruction 1230 not being received).

In another example embodiment, the method of flowchart 800 further includes one or more of the steps shown in flowchart 1000 of FIG. 10. As shown in FIG. 10, the method of flowchart 1000 begins at step 1002. In step 1002, an extent to which previous performance of the mitigation operation with regard to at least one service of the service(s) has negatively impacted the at least one service is determined. In an example implementation, the determination logic 1220 determines the extent to which previous performance of the mitigation operation with regard to the at least one service has negatively impacted the at least one service. For instance, the determination logic 1220 may retrieve the historical information 1234 from the store 1210 and analyze the historical information 1234 to determine the extent to which previous performance of the mitigation operation with regard to the at least one service has negatively impacted the at least one service. The determination logic 1220 may generate the determined information 1228 to indicate the extent to which previous performance of the mitigation operation with regard to the at least one service has negatively impacted the at least one service.

At step 1004, a determination is made whether the extent is less than or equal to an extent threshold. If the extent is less than or equal to the extent threshold, flow continues to step 1006. Otherwise, flow continues to step 1008. In an example implementation, the comparison logic 1222 determines whether the extent is less than or equal to the extent threshold. For instance, the comparison logic 1222 may compare the extent to the extent threshold to make the determination. The comparison logic 1222 may be configured to generate the execution instruction 1230, which instructs the execution logic 1224 to execute the executable troubleshooting guide, based on the extent being less than or equal to the extent threshold. The comparison logic 1222 may be configured to not generate the execution instruction 1230 based on the extent being greater than the extent threshold.

At step 1006, the executable troubleshooting guide is executed to mitigate the issue. In an example implementation, the execution logic 1224 executes the executable troubleshooting guide (e.g., based on receipt of the execution instruction 1230).

At step 1008, the executable troubleshooting guide is not executed to mitigate the issue. In an example implementation, the execution logic 1224 does not execute the executable troubleshooting guide (e.g., based on the execution instruction 1230 not being received).

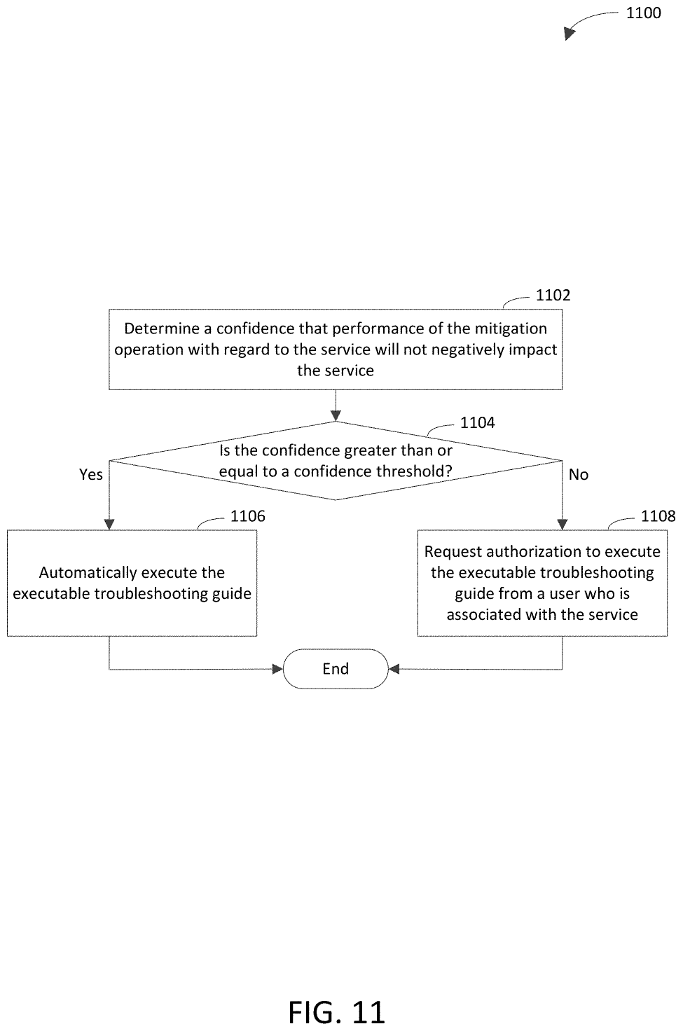

In yet another example embodiment, the method of flowchart 800 further includes one or more of the steps shown in flowchart 1100 of FIG. 11. As shown in FIG. 11, the method of flowchart 1100 begins at step 1102. In step 1102, a confidence that performance of the mitigation operation with regard to the service will not negatively impact the service is determined. In an example implementation, the determination logic 1220 determines the confidence that performance of the mitigation operation with regard to the service will not negatively impact the service. For example, the determination logic 1220 may retrieve the historical information 1234 from the store 1210 and analyze the historical information 1234 to determine the confidence. By analyzing the historical information 1234, the determination logic 1220 may determine an extent to which performance of the mitigation operation and/or any one or more of the historical operations that are correlated to the mitigation operation have negatively impacted the service or any one or more of the service(s) with regard to which those service(s) have been performed in the past. The determination logic 1220 may determine the confidence based on the aforementioned extents, which are determined by analyzing the historical information 1234. The determination logic 1220 may generate the determined information 1228 to indicate the confidence.

At step 1104, a determination is made whether the confidence is greater than or equal to a confidence threshold. If the confidence is greater than or equal to the confidence threshold, flow continues to step 1106. Otherwise, flow continues to step 1108. In an example implementation, the comparison logic 1222 determines whether the confidence is greater than or equal to the confidence threshold. For instance, the continuation logic 1222 may compare the confidence to the confidence threshold to make the determination. The comparison logic 1222 may be configured to generate the execution instruction 1230, which instructs the execution logic 1224 to execute the executable troubleshooting guide, based on the confidence being greater than or equal to the confidence threshold. The comparison logic 1222 may be configured to not generate the execution instruction 1230 based on the confidence being less than the confidence threshold.

At step 1106, the executable troubleshooting guide is automatically executed. In an example implementation, the execution logic 1224 automatically executes the executable troubleshooting guide (e.g., based on receipt of the execution instruction 1230).

At step 1108, authorization to execute the executable troubleshooting guide is requested from a user who is associated with the service. In an example implementation, the execution logic 1224 provides an authorization request 1244, which requests the authorization from the user (e.g., based on the execution instruction 1230 not being received). For instance, the execution logic 1224 may provide the authorization request 1244 in lieu of automatically executing the executable troubleshooting guide. The comparison logic 1222 may monitor communications that are received by the computing system 1200 to determine whether the computing system 1200 receives an authorization response 1246 from the user. For instance, the comparison logic 1222 may receive the authorization response 1246 from the user. The comparison logic 1222 may be configured to generate the execution instruction 1230 based on the authorization response 1246 indicating that the authorization to execute the executable troubleshooting guide is granted by the user. The comparison logic 1222 may be configured to not generate the execution instruction 1230 based on the authorization response 1246 indicating that the authorization to execute the executable troubleshooting guide is not granted by the user. Upon receipt of the execution instruction 1230, the execution logic 1224 may execute the executable troubleshooting guide.

It will be recognized that the computing system 1200 may not include one or more of the troubleshooting guide logic 1208, the store 1210, the issue identification logic 1212, the analysis logic 1214, the selection logic 1216, the generation logic 1218, the determination logic 1220, the comparison logic 1222, and/or the execution logic 1224. Furthermore, the computing system 1200 may include components in addition to or in lieu of the troubleshooting guide logic 1208, the store 1210, the issue identification logic 1212, the analysis logic 1214, the selection logic 1216, the generation logic 1218, the determination logic 1220, the comparison logic 1222, and/or the execution logic 1224.

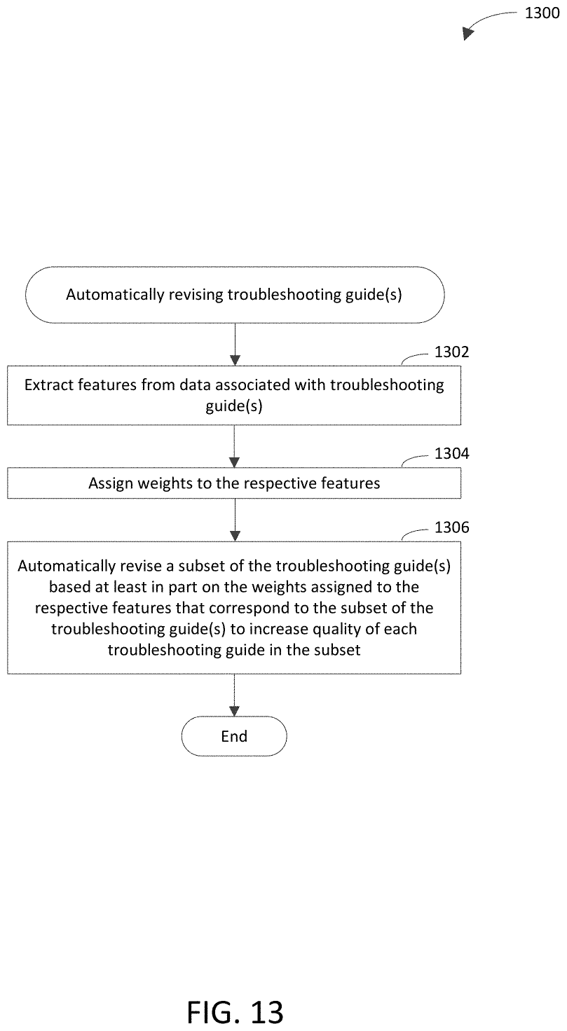

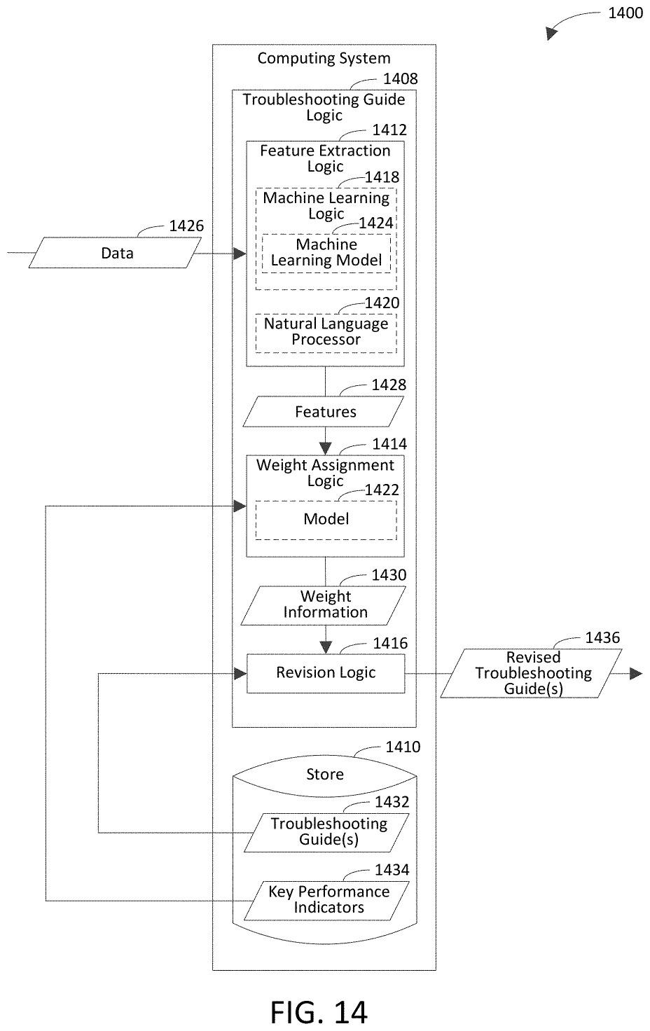

FIG. 13 depicts a flowchart 1300 of an example method for automatically revising troubleshooting guide(s) in accordance with an embodiment. Flowchart 1300 may be performed by the first server(s) 106A, shown in FIG. 1, for example. For illustrative purposes, flowchart 1300 is described with respect to computing system 1400 shown in FIG. 14, which is an example implementation of the first server(s) 106A. As shown in FIG. 14, the computing system 1400 includes troubleshooting guide logic 1408 and a store 1410. The troubleshooting guide logic 1408 includes feature extraction logic 1412, weight assignment logic 1414, and revision logic 1416. The feature extraction logic 1412 includes machine learning logic 1418 and a natural language processor 1420. The store 1410 may be any suitable type of store. One type of store is a database. For instance, the store 1410 may be a relational database, an entity-relationship database, an object database, an object relational database, or an extensible markup language (XML) database. The store 1410 is shown to store troubleshooting guide(s) 1432 and key performance indicators (KPIs) 1434 for illustrative purposes. Further structural and operational embodiments will be apparent to persons skilled in the relevant art(s) based on the discussion regarding flowchart 1300.

As shown in FIG. 13, the method of flowchart 1300 begins at step 1302. In step 1302, features are extracted from data associated with troubleshooting guide(s). Each feature indicates an attribute of at least one of the troubleshooting guide(s). In an example implementation, the feature extraction logic 1412 extracts features 1428 from data 1426 that is associated with the troubleshooting guide(s) 1432. In accordance with this implementation, each of the features 1428 indicates an attribute of at least one of the troubleshooting guide(s) 1432.

The data associated with the troubleshooting guide(s) may include explicit information, implicit information, and/or content information. Explicit information is information that is specified by user(s) of at least one of the troubleshooting guide(s). Examples of explicit information associated with a troubleshooting guide include a positive (e.g., “thumbs up” or “like”) tag, a positive comment (e.g., “This document is succinct yet thorough”), a negative (e.g., “thumbs down” or “dislike”) tag, and a negative comment (e.g., “You will need to perform these extra steps that are missing from the document”) regarding the troubleshooting guide that is received from a user of the troubleshooting guide.

Implicit information is information that is derived from use of at least one of the troubleshooting guide(s) and is not specified by user(s) of at least one of the troubleshooting guide(s). Examples of implicit information associated with a troubleshooting guide include a number of times the troubleshooting guide is viewed, an amount of time (e.g., average time) that users of the troubleshooting guide dwell on the troubleshooting guide (i.e., the time frame in which a user stays on the troubleshooting guide page), an extent (e.g., average extent) to which users of the troubleshooting guide scroll within the troubleshooting guide, an amount of time that is consumed to resolve an issue that a user uses the troubleshooting guide to resolve, and a number of users (e.g., daily active users or monthly active users) of the troubleshooting guide.

Content information is information that indicates characteristic(s) of content (e.g., structure) of at least one of the troubleshooting guide(s). Examples of content information include usability (e.g., readability) of the troubleshooting guide, completeness of the troubleshooting guide, correctness of the troubleshooting guide, whether the troubleshooting guide is nested in another document, whether the troubleshooting guide includes a nested document, ambiguity of the troubleshooting guide (e.g., an extent of subjective information that is included in the troubleshooting guide), an amount of time since the troubleshooting guide was created, an amount of time since the troubleshooting guide was most recently updated, whether the troubleshooting guide is empty, a length of the troubleshooting guide, whether the troubleshooting guide includes contact information of an entity that provides support to users of the troubleshooting guide, a number of commands that are included in the troubleshooting guide, whether the troubleshooting guide includes executable code or a pointer to executable code, a number of links that are included in the troubleshooting guide, whether the troubleshooting guide includes nested lists, a number of tables that are include in the troubleshooting guide, and a number of acronyms that are included in the troubleshooting guide.

A feature extracted from the data associated with the troubleshooting guide(s) may indicate that at least a subset of troubleshooting guide(s) associated with the feature (1) has a number of positive tags, positive comments, negative tags, negative comments, or users that is within a specified range of numbers; (2) is viewed a number of times that is within a specified range of numbers; (3) has a dwell time (e.g., average dwell time) that is within a specified range of dwell times; (4) has a scroll time (e.g., average scroll time) that is within a specified range of scroll times; (5) is used to resolve an issue for a period of time that is within a specified range of time periods; (6) has a usability, completeness, correctness, or ambiguity that is within a specified range of values; (7) is nested within another document; (8) includes a nested document; (9) was created or last updated at a time instance that is within a specified period of time in the past; (10) is empty; (11) has a length that is within a specified range of lengths; (12) includes contact information of a support entity; (13) includes a number of commands, links, tables, or acronyms that is within a specified range of numbers; (14) includes executable code or a pointer to executable code; (15) includes a nested list or a number of nested lists that is within a specified range of numbers, and so on.

In an example embodiment, the data associated with the troubleshooting guide(s) is stored across multiple independent clouds. Each of the independent clouds may be a public cloud or a private cloud. A public cloud is a cloud that is accessible to the general public. A private cloud is a cloud that is not accessible to the general public. For instance, access to the private cloud may be limited to only specified people or specified groups of people.

In another example embodiment, extracting the features at step 1302 includes executing code that is included in a troubleshooting guide that is included among the troubleshooting guide(s) to extract at least one of the features from the data associated with the troubleshooting guide(s).

In yet another example embodiment, extracting the features at step 1302 includes extracting the features from the data using a machine learning model. The machine learning model is configured to receive the data as input to the machine learning model and is further configured to derive the features as outputs of the machine learning model based on the data. For instance, the machine learning logic 1418 may extract the features 1428 using a machine learning model 1424 that is configured to receive the data 1426 as input to the machine learning model 1424 and that is further configured to derive the features 1428 as outputs of the machine learning model 1424 based on the data 1426.

In still another example embodiment, extracting the features at step 1302 includes extracting a feature that indicates a readability of at least one troubleshooting guide from the troubleshooting guide(s). For instance, extracting the feature may include causing a Flesch-Kincaid readability test to be performed (e.g., performing the Flesch-Kincaid readability test) on the at least one troubleshooting guide from which the feature is extracted. Readability of a troubleshooting guide may be based on (e.g., based at least in part on) a number of acronyms, tables, and/or nested lists in the troubleshooting guide. For instance, a relatively greater number of acronyms, tables, and/or nested lists in the troubleshooting guide may result in the troubleshooting guide having a relatively lower readability. A relatively lesser number of acronyms, tables, and/or nested lists in the troubleshooting guide may result in the troubleshooting guide having a relatively greater readability.

In an example embodiment, extracting the features at step 1302 includes extracting a feature that indicates a number of users who use at least one troubleshooting guide from the troubleshooting guide(s).

In another example embodiment, extracting the features at step 1302 includes extracting a feature that indicates a number of times at least one troubleshooting guide from the troubleshooting guide(s) is viewed.

In yet another example embodiment, extracting the features at step 1302 includes extracting a feature that indicates an amount of time that users of at least one troubleshooting guide from the troubleshooting guide(s) dwell on the respective troubleshooting guide.

In still another example embodiment, extracting the features at step 1302 includes extracting a feature that indicates an extent to which users of at least one troubleshooting guide from the troubleshooting guide(s) scroll on the respective troubleshooting guide.

In an example embodiment, extracting the features at step 1302 includes extracting a feature that indicates an extent to which language in at least one troubleshooting guide from the troubleshooting guide(s) is subjective (e.g., non-definitive) by analyzing the data that is included in the respective troubleshooting guide using natural language processing. For example, the feature extraction logic 1412 may extract the feature by analyzing the data (e.g., natural language data) that is included in each of the at least one troubleshooting guide using the natural language processing. In accordance with this example, the feature extraction logic 1412 may use a natural language processor 1420 to extract the feature. The natural language processor 1420 may be configured to understand the data and nuances of the language in the data. In one aspect, the natural language processor 1420 may be configured to automatically learn rules that are to be applied when analyzing the data. For instance, the natural language processor 1420 may use statistical inference algorithms to generate model(s) that are robust to unfamiliar input and to erroneous input. In another aspect, the rules may be handwritten.

In another example embodiment, extracting the features at step 1302 includes extracting a feature that indicates an amount of time since at least one troubleshooting guide from the troubleshooting guide(s) was created or updated. For instance, the feature may indicate whether the amount of time is greater than or equal to a threshold amount of time. It will be recognized that “freshness” of a troubleshooting guide may be inversely proportional to the amount of time since the troubleshooting guide was created or last updated.

In yet another example embodiment, extracting the features at step 1302 includes extracting a feature that indicates explicit feedback regarding at least one troubleshooting guide from the troubleshooting guide(s) from users of the respective troubleshooting guide. For instance, the explicit feedback regarding each of the at least one troubleshooting guide may include subjective ratings of the respective troubleshooting guide from the respective users of the respective troubleshooting guide.

In still another example embodiment, extracting the features at step 1302 includes extracting a feature that indicates that at least one troubleshooting guide from the troubleshooting guide(s) is empty.

In an example embodiment, extracting the features at step 1302 includes extracting a feature that indicates that at least one troubleshooting guide from the troubleshooting guide(s) has a length that is greater than or equal to a length threshold.

In another example embodiment, extracting the features at step 1302 includes extracting a feature that indicates whether a troubleshooting guide from the troubleshooting guide(s) includes contact information of a person or a group of persons to be contacted for assistance with the troubleshooting guide.

In yet another example embodiment, extracting the features at step 1302 includes extracting a feature that indicates whether at least one troubleshooting guide from the troubleshooting guide(s) includes a number of commands that is greater than or equal to a threshold number.

In still another example embodiment, extracting the features at step 1302 includes extracting a feature that indicates whether at least one troubleshooting guide from the troubleshooting guide(s) includes a number of links that is greater than or equal to a threshold number.

At step 1304, weights are assigned to the respective features. For example, each weight may represent an importance of the respective feature. In another example, each weight may represent a ranking of the respective feature with reference to the other features. In an aspect, the weights may be assigned using a model, machine learning, rules, and/or heuristics. It will be recognized that the model may be any suitable type of model. For instance, the model may be a regression model or a classification model. Examples of a regression model include a linear regression model, a nonlinear regression model, a polynomial regression model, and a logistic regression model. In another aspect, the weights may be assigned manually. For instance, the weights may be assigned equally among the features such that each feature has the same weight as each other feature.

In an example embodiment, the weights are assigned to the respective features based at least in part on key performance indicators associated with the troubleshooting guide(s). Each key performance indicator specifies an extent to which a respective troubleshooting guide from the troubleshooting guide(s) satisfies one or more criteria. One example criterion is that quality of the troubleshooting guide is greater than or equal to a threshold quality. Quality of a troubleshooting guide may be derived from attributes of the troubleshooting guide and/or features with which the troubleshooting guide is associated. Another example criterion is that an extent to which the troubleshooting guide is used by users is greater than or equal to a threshold extent of usage. The extent to which a troubleshooting guide is used may be based at least in part on an amount of time that the troubleshooting guide is opened by users of the troubleshooting guide, a number of users who access the document, and/or an amount of time that the users dwell on the troubleshooting guide. Yet another example criterion is that coverage of the troubleshooting guide is greater than or equal to a coverage threshold. Coverage of a troubleshooting guide indicates a number of issues that the troubleshooting guide is configured to be used to resolve or has been used to resolve in the past.

In an example implementation, the weight assignment logic 1414 assigns weights to the respective features 1428. For example, the weight assignment logic 1414 may assign the weights to the respective features 1428 using a model 1422 based at least in part on KPIs 1434 associated with the troubleshooting guide(s). In accordance with this example, the weight assignment logic 1414 may use the model 1422 to analyze (e.g., perform regression analysis or classification analysis on) the KPIs 1434 to predict or forecast the weights that are to be assigned to the respective features 1428. In further accordance with this example, the weight assignment logic 1414 may retrieve the KPIs 1434 from the store 1410 so that the KPIs 1434 may be analyzed. The weight assignment logic 1414 may generate weight information 1430 in response to assigning the weights to the respective features 1428. For instance, the weight information 1430 may specify the weights and cross-reference the weights with the respective features 1428.

At step 1306, a subset of the troubleshooting guide(s) is automatically revised based at least in part on the weights assigned to the respective features that correspond to the subset of the troubleshooting guide(s) to increase quality of each troubleshooting guide in the subset. The subset of the troubleshooting guide(s) includes one or more of the troubleshooting guide(s). For example, the subset may include all of the troubleshooting guide(s). In another example, the subset may include fewer than all of the troubleshooting guide(s). A troubleshooting guide may be revised in any of a variety of ways. For instance the troubleshooting guide may revised to include a more thorough explanation of each step that is to be performed to mitigate an issue, to add missing steps that are to be performed to mitigate the issue, to remove redundant information, to clarify language in the troubleshooting guide, to convert subjective language to objective language, to reduce a length of the troubleshooting guide so that the troubleshooting guide becomes more concise, to change language in the troubleshooting guide to become more accurate and/or to incorporate explicit feedback from users of the troubleshooting guide, to include contact information of a person or a group of persons to be contacted for assistance with the troubleshooting guide, to reduce a number of commands in the troubleshooting guide, and/or to reduce a number of links in the troubleshooting guide. The quality of a troubleshooting guide represents a degree of excellence of the troubleshooting guide or a superiority in kind of the troubleshooting guide. The quality of the troubleshooting guide may be based on any of a variety of factors, including utility, ease of use (e.g., clarity, conciseness), reputation (e.g., among users of the troubleshooting guide), and accuracy of the troubleshooting guide.

In an example implementation, the revision logic 1416 automatically revises the subset of the troubleshooting guide(s). For instance, the revision logic 1416 may analyze the weight information to identify the weights and the features 1428, to determine which of the weights corresponds to each of the features 1428, and to determine which one or more of the features 1428 correspond to each of the troubleshooting guide(s). Based on this analysis, the revision logic 1416 may determine whether each of the troubleshooting guide(s) is to be automatically revised. For instance, the revision logic 1416 may determine that a troubleshooting guide is to be automatically revised a result of the features 1428 and the weights satisfying designated condition(s). The revision logic 1416 may determine that the troubleshooting guide is not to be automatically revised as a result of the features 1428 and the weights not satisfying the designated condition(s). For instance, a designated condition may require that a troubleshooting guide has a specified feature (e.g., any of the features described above) and/or that a feature of the troubleshooting guide (e.g., the specified feature) has a weight that is greater than or equal to a weight threshold. The weight threshold may be any suitable numerical value (e.g., 0.05, 0.20, 2, or 15). The weights described herein may be normalized weights, though the example embodiments is not limited in this respect. For instance, the weights may be in a range from zero to one.

In some example embodiments, one or more steps 1302, 1304, and/or 1306 of flowchart 1300 may not be performed. Moreover, steps in addition to or in lieu of steps 1302, 1304, and/or 1306 may be performed.

It will be recognized that the computing system 1400 may not include one or more of the troubleshooting guide logic 1408, the store 1410, the feature extraction logic 1412, the weight assignment logic 1414, the revision logic 1416, the machine learning logic 1418, and/or the natural language processor 1420. Furthermore, the computing system 1400 may include components in addition to or in lieu of the troubleshooting guide logic 1408, the store 1410, the feature extraction logic 1412, the weight assignment logic 1414, the revision logic 1416, the machine learning logic 1418, and/or the natural language processor 1420.

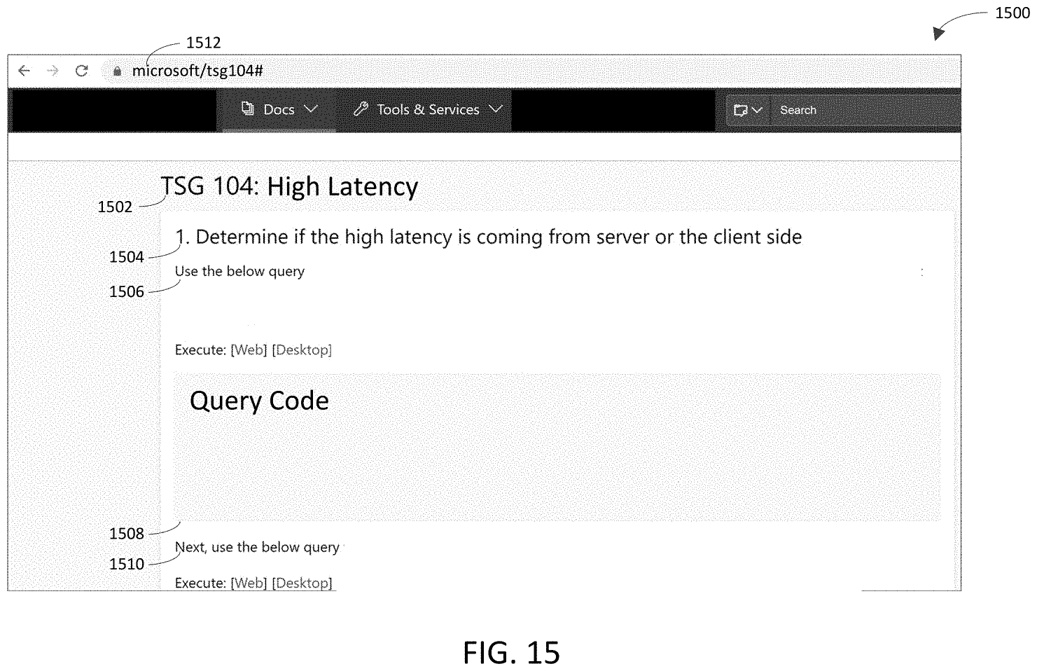

FIG. 15 depicts an example troubleshooting guide 1500 associated with a database, which is implemented in code, in accordance with an embodiment. As shown in FIG. 15, the troubleshooting guide 1500 includes identifying information 1502. The identifying information 1502 indicates that the troubleshooting guide 1500 has been assigned number “104” and is named “High Latency.” The troubleshooting guide 1500 further includes a goal statement 1504, a first instruction 1506, code 1508, and a second instruction 1510. The goal statement 1504 indicates a goal or a purpose that is to be achieved using the first and second instructions 1506 and 1510 and the code 1508. The goal statement reads, “1. Determine if the high latency is coming from server or the client side.” The first instruction reads, “Use below query.” The code 1508 includes the query mentioned in the first instruction 1506. The second instruction 1510 reads, “Next, use the below query” The query mentioned in the second instruction 1510 is not shown.

The troubleshooting guide 1500 is shown to be included in a graphical user interface (GUI) in FIG. 15 for illustrative purposes. The GUI includes a uniform resource locator (URL) 1512 to indicate a location at which the troubleshooting guide 1500 is stored.

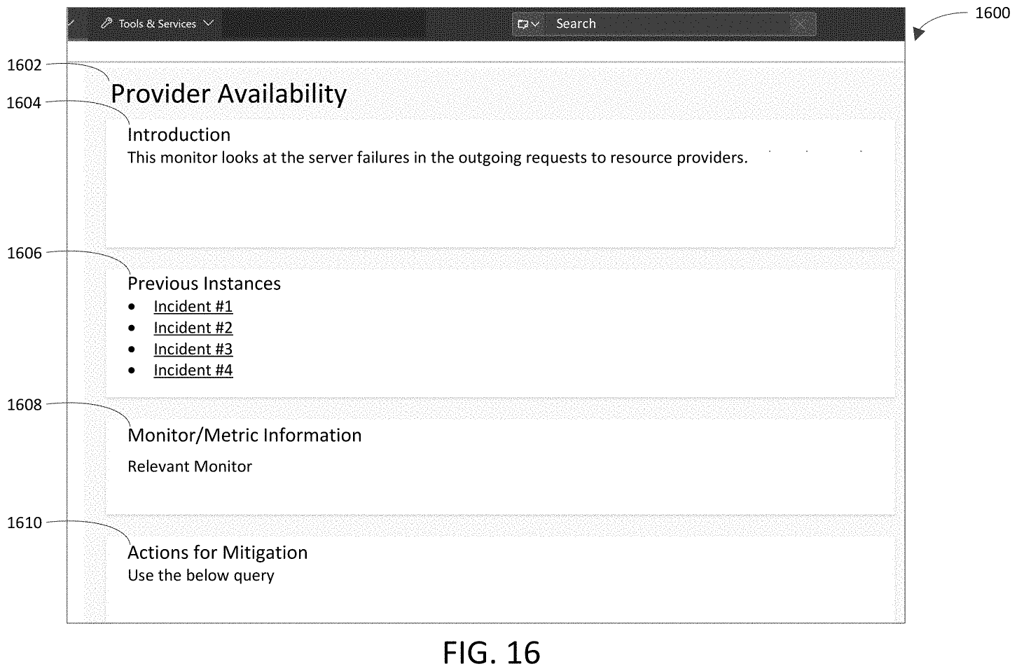

FIG. 16 depicts another example troubleshooting guide 1600 associated with a monitor, which is implemented in code, in accordance with an embodiment. As shown in FIG. 16, the troubleshooting guide 1600 includes identifying information 1602. The identifying information 1602 indicates that the troubleshooting guide 1600 is named “Provider Availability.” The troubleshooting guide 1600 further includes an introduction 1604, which reads, “This monitor looks at the server failures in the outgoing requests to resource providers.”

The troubleshooting guide 1600 identifies previous instances 1606 of server failures, which are identified by respective links for illustrative purposes. It will be recognized that the previous instances 1606 may be identified by respective URLs. For instance, information regarding a first server failure is shown to be located at a destination corresponding to the link “Incident #1.” Information regarding a second server failure is shown to be located at a destination corresponding to the link “Incident #2.” Information regarding a third server failure is shown to be located at a destination corresponding to the link “Incident #3.” Information regarding a fourth server failure is shown to be located at a destination corresponding to the link “Incident #4.”

The troubleshooting guide 1600 further includes monitor/metric information 1608, which identifies the monitor with which the troubleshooting guide 1600 is associated. The troubleshooting guide 1600 identifies actions for mitigation 1610. The actions for mitigation 1610 include a recommendation, which reads, “Use the below query.”

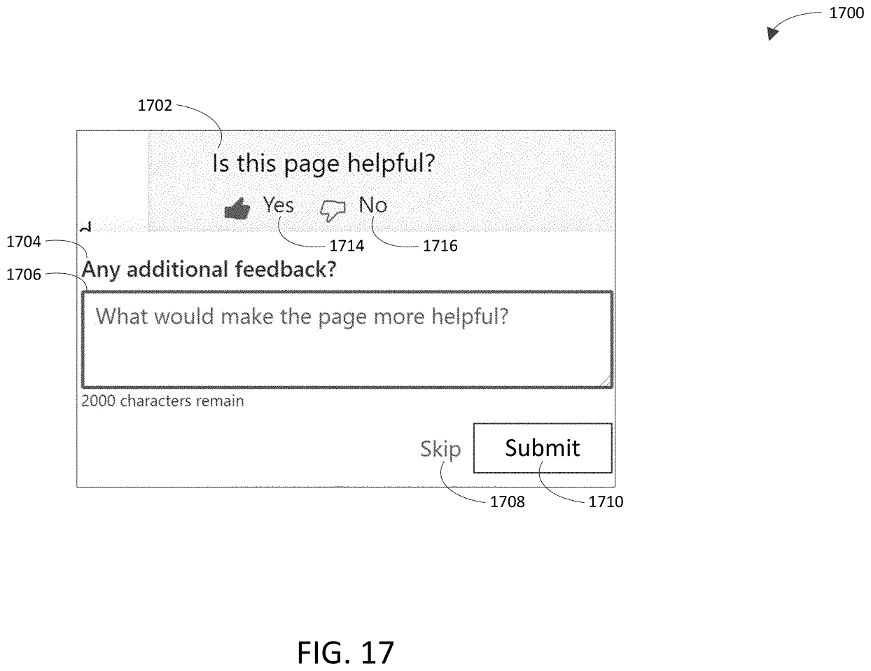

FIG. 17 depicts an example graphical user interface (GUI) 1700 that solicits explicit feedback from a user of a troubleshooting guide in accordance with an embodiment. The GUI 1700 includes a first solicitation 1702, which reads, “Is this page helpful?” The page to which the first solicitation 1702 refers is a page that includes the troubleshooting guide. A “Yes” interface element 1714 and a “No” interface element 1716 are associated with the first solicitation 1702. Each of the “Yes” interface element 1714 and the “No” interface element 1716 is selectable by the user to indicate the corresponding response to the first solicitation 1702. The GUI 1700 further includes a second solicitation 1704, which reads, “Any additional feedback?” The GUI 1700 further includes a text box 1706 in which the user may type any additional feedback that the user may have up to 2000 characters. For instance, the user may type, “Need explanation on ‘likely not related to an ARM issue’ and ‘usually transferred to RP’” in the text box 1706. The GUI 1700 further includes a “Skip” button 1708 and a “Submit” button 1710. The “Skip” button is selectable by the user to enable the user to avoid providing feedback regarding the troubleshooting guide. For instance, selection of the “Skip” button 1708 may cause the GUI 1700 to close (e.g., disappear). The “Submit” button 1710 is selectable by the user to enable the user to submit feedback that the user may have provided in the text box 1706 and/or using either of the interface elements 1714 and 1716.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the troubleshooting guide logic 108, the troubleshooting guide logic 708, the schema logic 712, the selection logic 714, the generation logic 716, the issue identification logic 718, the determination logic 720, the execution logic 722, the troubleshooting guide logic 1208, the issue identification logic 1212, the analysis logic 1214, the selection logic 1216, the generation logic 1218, the determination logic 1220, the comparison logic 1222, the execution logic 1224, the troubleshooting guide logic 1408, the feature extraction logic 1412, the weight assignment logic 1414, the revision logic 1416, the machine learning logic 1418, the natural language processor 1420, flowchart 200, flowchart 300, flowchart 400, flowchart 500, flowchart 600, flowchart 800, flowchart 900, flowchart 1000, flowchart 1100, and/or flowchart 1300 may be implemented in hardware, software, firmware, or any combination thereof.

For example, any one or more of the troubleshooting guide logic 108, the troubleshooting guide logic 708, the schema logic 712, the selection logic 714, the generation logic 716, the issue identification logic 718, the determination logic 720, the execution logic 722, the troubleshooting guide logic 1208, the issue identification logic 1212, the analysis logic 1214, the selection logic 1216, the generation logic 1218, the determination logic 1220, the comparison logic 1222, the execution logic 1224, the troubleshooting guide logic 1408, the feature extraction logic 1412, the weight assignment logic 1414, the revision logic 1416, the machine learning logic 1418, the natural language processor 1420, flowchart 200, flowchart 300, flowchart 400, flowchart 500, flowchart 600, flowchart 800, flowchart 900, flowchart 1000, flowchart 1100, and/or flowchart 1300 may be implemented, at least in part, as computer program code configured to be executed in a processing system.

In another example, any one or more of the troubleshooting guide logic 108, the troubleshooting guide logic 708, the schema logic 712, the selection logic 714, the generation logic 716, the issue identification logic 718, the determination logic 720, the execution logic 722, the troubleshooting guide logic 1208, the issue identification logic 1212, the analysis logic 1214, the selection logic 1216, the generation logic 1218, the determination logic 1220, the comparison logic 1222, the execution logic 1224, the troubleshooting guide logic 1408, the feature extraction logic 1412, the weight assignment logic 1414, the revision logic 1416, the machine learning logic 1418, the natural language processor 1420, flowchart 200, flowchart 300, flowchart 400, flowchart 500, flowchart 600, flowchart 800, flowchart 900, flowchart 1000, flowchart 1100, and/or flowchart 1300 may be implemented, at least in part, as hardware logic/electrical circuitry. Such hardware logic/electrical circuitry may include one or more hardware logic components. Examples of a hardware logic component include a field-programmable gate array (FPGA), an application-specific integrated circuit (ASIC), an application-specific standard product (ASSP), a system-on-a-chip system (SoC), and a complex programmable logic device (CPLD). For instance, a SoC may include an integrated circuit chip that includes one or more of a processor (e.g., a microcontroller, microprocessor, or digital signal processor (DSP)), memory, one or more communication interfaces, and/or further circuits and/or embedded firmware to perform its functions.

### III. FURTHER DISCUSSION OF SOME EXAMPLE EMBODIMENTS

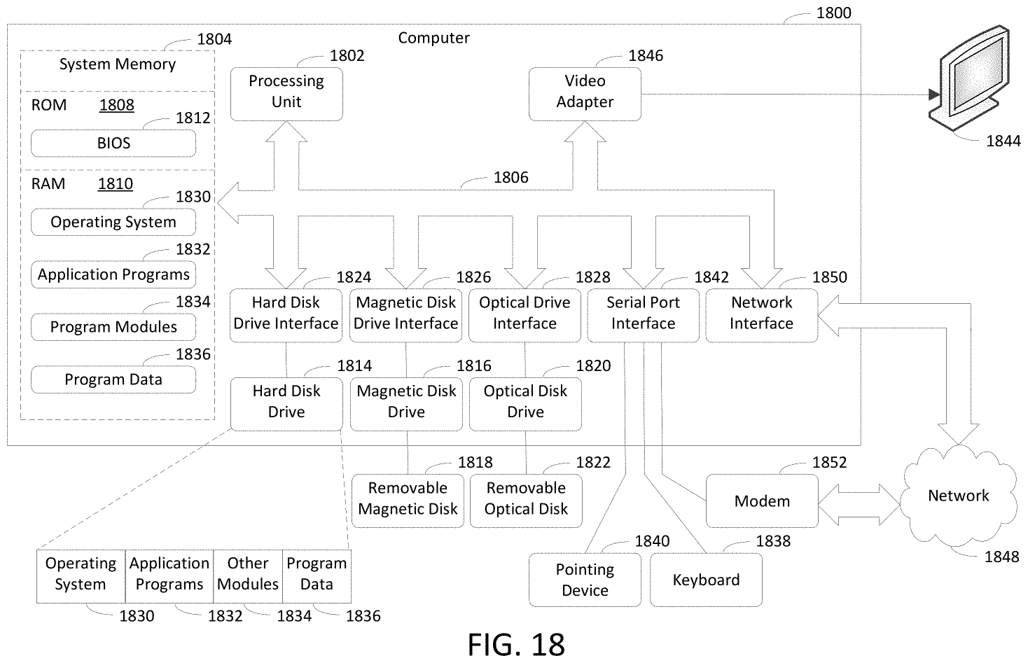

(A1) A first example system (FIG. 1, 102A-102M, 106A-106N; FIG. 7, 700; FIG. 18, 1800) comprises a memory (FIG. 18, 1804, 1808, 1810) and a processing system (FIG. 18, 1802) coupled to the memory. The processing system is configured to determine (FIG. 2, 202) a schema (FIG. 7, 726) that defines at least a subset of operations that are capable of being performed with regard to a service. The processing system is further configured to select (FIG. 2, 204) a mitigation operation from the operations defined by the schema based at least in part on historical information (FIG. 7, 734), which indicates historical operations that have been performed previously to mitigate issues associated with the service, indicating that the mitigation operation is capable of mitigating a category of issues. The processing system is further configured to automatically generate (FIG. 2, 206) an executable troubleshooting guide (FIG. 7, 738) in response to the mitigation operation being selected from the operations, the executable troubleshooting guide being configured to perform the mitigation operation.

(A2) In the system of A1, wherein the processing system is further configured to: identify an issue that occurs with regard to the service; determine that the issue is included in the category of issues; and automatically execute the executable troubleshooting guide to mitigate the issue based at least in part on a determination that the issue is included in the category of issues.

(A3) In the system of any of A1-A2, wherein the processing system is further configured to: identify an issue that occurs with regard to the service; determine that the issue is included in the category of issues; present an inquiry, which inquires whether the executable troubleshooting guide is to be executed to mitigate the issue, based at least in part on a determination that the issue is included in the category of issues; and selectively execute the executable troubleshooting guide to mitigate the issue depending on whether a response that indicates that the executable troubleshooting guide is to be executed is received in response to the inquiry.

(A4) In the system of any of A1-A3, wherein the processing system is configured to: determine that an issue has occurred with regard to the service; and determine that the mitigation operation is capable of mitigating the issue based at least in part on the issue being included in the category of issues that the mitigation operation is capable of mitigating.

(A5) In the system of any of A1-A4, wherein the processing system is configured to: determine the schema based at least in part on the operations that have been performed previously to mitigate issues associated with the service, as indicated by the historical information.

(A6) In the system of any of A1-A5, wherein the processing system is configured to: determine the schema based at least in part on the operations that are capable of being performed with regard to the service being identified in a document associated with a user of the service or in instructions associated with the user of the service.

(A7) In the system of any of A1-A6, automatically generate the executable troubleshooting guide to be conditionally executable such that authentication is a prerequisite for execution of the troubleshooting guide; provide a request for a credential from a user associated with the service; compare the credential that is received in response to the request and a reference credential that corresponds to the user to determine whether the user is authenticated; and execute the executable troubleshooting guide based at least in part on a determination that the user is authenticated as a result of the credential that is received in response to the request corresponding to the reference credential.

(A8) In the system of any of A1-A7, wherein the processing system is further configured to: receive an indication that a user associated with the service seeks to execute the executable troubleshooting guide; compare at least one permission of the user to at least one reference permission; and execute the executable troubleshooting guide based at least in part on the at least one permission of the user corresponding to the at least one reference permission.

(B1) A second example system (FIG. 1, 102A-102M, 106A-106N; FIG. 12, 1200; FIG. 18, 1800) comprises a memory (FIG. 18, 1804, 1808, 1810) and a processing system (FIG. 18, 1802) coupled to the memory. The processing system is configured to identify (FIG. 8, 802) an issue that occurs with regard to a service. The processing system is further configured to analyze (FIG. 8, 804) historical information (FIG. 12, 1234) to identify historical operations that have been performed previously with regard to one or more services to mitigate issues associated with the one or more services. The processing system is further configured to select (FIG. 8, 806) a mitigation operation from the historical operations based at least in part on the historical information indicating that the mitigation operation is capable of mitigating a category of issues that includes the issue. The processing system is further configured to automatically generate (FIG. 8, 808) an executable troubleshooting guide (FIG. 12, 1240) in response to selecting the mitigation operation from the historical operations, the executable troubleshooting guide being configured to perform the mitigation operation.

(B2) In the system of B1, wherein the processing system is further configured to: estimate a severity of the issue based at least in part on an extent to which a plurality of key performance indicators associated with the service fails to satisfy one or more criteria as a result of the issue occurring with regard to the service; and execute the executable troubleshooting guide to mitigate the issue based at least in part on the severity of the issue being greater than or equal to a severity threshold.

(B3) In the system of any of B1-B2, wherein the processing system is further configured to: determine an extent to which previous performance of the mitigation operation with regard to at least one service of the one or more services has negatively impacted the at least one service; and execute the executable troubleshooting guide to mitigate the issue based at least in part on the extent being less than or equal to an extent threshold.

(B4) In the system of any of B1-B3, wherein the processing system is configured to: determine a confidence that performance of the mitigation operation with regard to the service will not negatively impact the service; and automatically execute the executable troubleshooting guide as a result of the confidence being greater than or equal to a confidence threshold.

(B5) In the system of any of B1-B4, wherein the processing system is configured to: determine a confidence that performance of the mitigation operation with regard to the service will not negatively impact the service; and request authorization to execute the executable troubleshooting guide from a user who is associated with the service as a result of the confidence being less than the confidence threshold.

(B6) In the system of any of B1-B5, wherein the processing system is configured to: determine a subset of the one or more services such that each service in the subset and the service with regard to which the issue is identified have one or more characteristics in common; and select the mitigation operation from the historical operations based at least in part on the historical information indicating that the mitigation operation has been performed with regard to at least one service in the sub set.

(B7) In the system of any of B1-B6, wherein the processing system is configured to: automatically generate the executable troubleshooting guide to be conditionally executable such that authentication is a prerequisite for execution of the troubleshooting guide; provide a request for a credential from a user associated with the service; compare the credential that is received in response to the request and a reference credential that corresponds to the user to determine whether the user is authenticated; and execute the executable troubleshooting guide based at least in part on a determination that the user is authenticated as a result of the credential that is received in response to the request corresponding to the reference credential.

(B8) In the system of any of B1-B7, wherein the processing system is further configured to: receive an indication that a user associated with the service seeks to execute the executable troubleshooting guide; compare at least one permission of the user to at least one reference permission; and selectively execute the executable troubleshooting guide based at least in part on whether the at least one permission of the user corresponds to the at least one reference permission.

(C1) A third example system (FIG. 1, 102A-102M, 106A-106N; FIG. 14, 1400; FIG. 18, 1800) comprises a memory (FIG. 18, 1804, 1808, 1810) and a processing system (FIG. 18, 1802) coupled to the memory. The processing system is configured to extract (FIG. 13, 1302) features (FIG. 14, 1428) from data (FIG. 14, 1426) associated with one or more troubleshooting guides (FIG. 14, 1432) that are associated with at least one of code or an application programming interface (API). Each troubleshooting guide includes instructions that describe operations to be performed to resolve issues associated with the at least one of the code or the API. Each feature indicates an attribute of at least one troubleshooting guide from the one or more troubleshooting guides. The processing system is further configured to assign (FIG. 13, 1304) weights to the respective features. The processing system is further configured to automatically revise (FIG. 13, 1306) a subset of the one or more troubleshooting guides based at least in part on the weights assigned to the respective features that correspond to the subset of the one or more troubleshooting guides to increase quality of each troubleshooting guide in the subset.

(C2) In the system of C1, wherein the processing system is configured to:

assign the weights to the respective features using a model based at least in part on key performance indicators associated with the one or more troubleshooting guides, each key performance indicator specifying an extent to which a respective troubleshooting guide from the one or more troubleshooting guides satisfies one or more criteria.

(C3) In the system of any of C1-C2, wherein data associated with the one or more troubleshooting guides are stored across multiple independent clouds.

(C4) In the system of any of C1-C3, wherein the processing system is configured to: extract at least one of the features from the data associated with the one or more troubleshooting guides by executing code that is include in a troubleshooting guide of the one or more troubleshooting guides.

(C5) In the system of any of C1-C4, wherein the processing system is configured to: extract the features from the data using a machine learning model, the machine learning model configured to receive the data as input to the machine learning model and further configured to derive the features as outputs of the machine learning model based on the data.

(C6) In the system of any of C1-C5, wherein the processing system is configured to: extract a feature that indicates at least one of the following attributes: a readability of at least one of the one or more troubleshooting guides; a number of users who use at least one of the one or more troubleshooting guides; a number of times at least one of the one or more troubleshooting guides is viewed.

(C7) In the system of any of C1-C6, wherein the processing system is configured to: extract a feature that indicates at least one of the following attributes: an amount of time that users of at least one of the one or more troubleshooting guides dwell on the respective troubleshooting guide; an extent to which the users of at least one of the one or more troubleshooting guides scroll on the respective troubleshooting guide; an extent to which language in at least one of the one or more troubleshooting guides is subjective by analyzing the data that is included in the respective troubleshooting guide using natural language processing.

(C8) In the system of any of C1-C7, wherein the processing system is configured to: extract a feature that indicates at least one of the following attributes: an amount of time since at least one of the one or more troubleshooting guides was created or updated; explicit feedback regarding at least one of the one or more troubleshooting guides from users of the respective troubleshooting guide; at least one of the one or more troubleshooting guides is empty; at least one of the one or more troubleshooting guides has a length that is greater than or equal to a length threshold.

(D1) A first example method, which is implemented by a computing system (FIG. 1, 102A-102M, 106A-106N; FIG. 7, 700; FIG. 18, 1800), comprises determining (FIG. 2, 202) a schema (FIG. 7, 726) that defines at least a subset of operations that are capable of being performed with regard to a service. The first example method further comprises selecting (FIG. 2, 204) a mitigation operation from the operations defined by the schema based at least in part on historical information (FIG. 7, 734), which indicates historical operations that have been performed previously to mitigate issues associated with the service, indicating that the mitigation operation is capable of mitigating a category of issues. The first example method further comprises automatically generating (FIG. 2, 206) an executable troubleshooting guide (FIG. 7, 738) in response to selecting the mitigation operation from the operations, the executable troubleshooting guide being configured to perform the mitigation operation.

(D2) In the method of D1, further comprising: identifying an issue that occurs with regard to the service; determining that the issue is included in the category of issues; and automatically executing the executable troubleshooting guide to mitigate the issue based at least in part on determining that the issue is included in the category of issues.

(D3) In the method of any of D1-D2, further comprising: identifying an issue that occurs with regard to the service; determining that the issue is included in the category of issues; presenting an inquiry, which inquires whether the executable troubleshooting guide is to be executed to mitigate the issue, based at least in part on determining that the issue is included in the category of issues; and selectively executing the executable troubleshooting guide to mitigate the issue depending on whether a response that indicates that the executable troubleshooting guide is to be executed is received in response to the inquiry.

(D4) In the method of any of D1-D3, further comprising: determining that an issue has occurred with regard to the service; and determining that the mitigation operation is capable of mitigating the issue based at least in part on the issue being included in the category of issues that the mitigation operation is capable of mitigating.

(D5) In the method of any of D1-D4, wherein determining the schema comprises: determining the schema based at least in part on the operations that have been performed previously to mitigate issues associated with the service, as indicated by the historical information.

(D6) In the method of any of D1-D5, wherein determining the schema comprises: determining the schema based at least in part on the operations that are capable of being performed with regard to the service being identified in a document associated with a user of the service or in instructions associated with the user of the service.

(D7) In the method of any of D1-D6, wherein automatically generating the executable troubleshooting guide comprises: automatically generating the executable troubleshooting guide to be conditionally executable such that authentication is a prerequisite for execution of the troubleshooting guide; and wherein the method further comprises: providing a request for a credential from a user associated with the service; comparing the credential that is received in response to the request and a reference credential that corresponds to the user to determine whether the user is authenticated; and executing the executable troubleshooting guide based at least in part on a determination that the user is authenticated as a result of the credential that is received in response to the request corresponding to the reference credential.

(D8) In the method of any of D1-D7, further comprising: receiving an indication that a user associated with the service seeks to execute the executable troubleshooting guide; comparing at least one permission of the user to at least one reference permission; and executing the executable troubleshooting guide based at least in part on the at least one permission of the user corresponding to the at least one reference permission.

(E1) A second example method, which is implemented by a computing system (FIG. 1, 102A-102M, 106A-106N; FIG. 12, 1200; FIG. 18, 1800), comprises identifying (FIG. 8, 802) an issue that occurs with regard to a service. The second example method further comprises analyzing (FIG. 8, 804) historical information (FIG. 12, 1234) to identify historical operations that have been performed previously with regard to one or more services to mitigate issues associated with the one or more services. The second example method further comprises selecting (FIG. 8, 806) a mitigation operation from the historical operations based at least in part on the historical information indicating that the mitigation operation is capable of mitigating a category of issues that includes the issue. The second example method further comprises automatically generating (FIG. 8, 808) an executable troubleshooting guide (FIG. 12, 1240) in response to selecting the mitigation operation from the historical operations, the executable troubleshooting guide being configured to perform the mitigation operation.

(E2) In the method of E1, further comprising: estimating a severity of the issue based at least in part on an extent to which a plurality of key performance indicators associated with the service fails to satisfy one or more criteria as a result of the issue occurring with regard to the service; and executing the executable troubleshooting guide to mitigate the issue based at least in part on the severity of the issue being greater than or equal to a severity threshold.

(E3) In the method of any of E1-E2, further comprising: determining an extent to which previous performance of the mitigation operation with regard to at least one service of the one or more services has negatively impacted the at least one service; and executing the executable troubleshooting guide to mitigate the issue based at least in part on the extent being less than or equal to an extent threshold.

(E4) In the method of any of E1-E3, further comprising: determining a confidence that performance of the mitigation operation with regard to the service will not negatively impact the service; and automatically executing the executable troubleshooting guide as a result of the confidence being greater than or equal to a confidence threshold.

(E5) In the method of any of E1-E4, further comprising: determining a confidence that performance of the mitigation operation with regard to the service will not negatively impact the service; and requesting authorization to execute the executable troubleshooting guide from a user who is associated with the service as a result of the confidence being less than the confidence threshold.

(E6) In the method of any of E1-E5, further comprising: determining a subset of the one or more services such that each service in the subset and the service with regard to which the issue is identified have one or more characteristics in common; wherein selecting the mitigation operation comprises: selecting the mitigation operation from the historical operations based at least in part on the historical information indicating that the mitigation operation has been performed with regard to at least one service in the subset.

(E7) In the method of any of E1-E6, wherein automatically generating the executable troubleshooting guide comprises: automatically generating the executable troubleshooting guide to be conditionally executable such that authentication is a prerequisite for execution of the troubleshooting guide; and wherein the method further comprises: providing a request for a credential from a user associated with the service; comparing the credential that is received in response to the request and a reference credential that corresponds to the user to determine whether the user is authenticated; and executing the executable troubleshooting guide based at least in part on a determination that the user is authenticated as a result of the credential that is received in response to the request corresponding to the reference credential.

(E8) In the method of any of E1-E7, further comprising: receiving an indication that a user associated with the service seeks to execute the executable troubleshooting guide; comparing at least one permission of the user to at least one reference permission; and selectively executing the executable troubleshooting guide based at least in part on whether the at least one permission of the user corresponds to the at least one reference permission.

(F1) A third example method, which is implemented by a computing system (FIG. 1, 102A-102M, 106A-106N; FIG. 14, 1400; FIG. 18, 1800), comprises extracting (FIG. 13, 1302) features (FIG. 14, 1428) from data (FIG. 14, 1426) associated with one or more troubleshooting guides (FIG. 14, 1432) that are associated with at least one of code or an application programming interface (API). Each troubleshooting guide includes instructions that describe operations to be performed to resolve issues associated with the at least one of the code or the API. Each feature indicates an attribute of at least one troubleshooting guide from the one or more troubleshooting guides. The third example method further comprises assigning (FIG. 13, 1304) weights to the respective features. The third example method further comprises automatically revising (FIG. 13, 1306) a subset of the one or more troubleshooting guides based at least in part on the weights assigned to the respective features that correspond to the subset of the one or more troubleshooting guides to increase quality of each troubleshooting guide in the subset.

(F2) In the method of F1, wherein extracting the features from the data associated with the one or more troubleshooting guides comprises: extracting a feature that indicates an extent to which language in each of at least one troubleshooting guide from the one or more troubleshooting guides is subjective by analyzing the data that is included in the respective troubleshooting guide using natural language processing.

(F3) In the method of any of F1-F2, wherein extracting the features from the data associated with the one or more troubleshooting guides comprises: extracting at least one of the features from the data associated with the one or more troubleshooting guides by executing code that is include in a troubleshooting guide of the one or more troubleshooting guides.

(F4) In the method of any of F1-F3, wherein extracting the features from the data associated with the one or more troubleshooting guides is performed using a machine learning model, the machine learning model configured to receive the data as input to the machine learning model and further configured to derive the features as outputs of the machine learning model based on the data.

(F5) In the method of any of F1-F4, wherein extracting the features from the data associated with the one or more troubleshooting guides comprises: extracting a feature that indicates at least one of the following attributes: a readability of at least one of the one or more troubleshooting guides; a number of users who use at least one of the one or more troubleshooting guides; a number of times at least one of the one or more troubleshooting guides is viewed.

(F6) In the method of any of F1-F5, wherein extracting the features from the data associated with the one or more troubleshooting guides comprises: extracting a feature that indicates at least one of the following attributes: an amount of time that users of at least one of the one or more troubleshooting guides dwell on the respective troubleshooting guide; an extent to which the users of at least one of the one or more troubleshooting guides scroll on the respective troubleshooting guide; an extent to which language in at least one of the one or more troubleshooting guides is subjective by analyzing the data that is included in the respective troubleshooting guide using natural language processing.

(F7) In the method of any of F1-F6, wherein extracting the features from the data associated with the one or more troubleshooting guides comprises: extracting a feature that indicates at least one of the following attributes: an amount of time since at least one of the one or more troubleshooting guides was created or updated; explicit feedback regarding at least one of the one or more troubleshooting guides from users of the respective troubleshooting guide; at least one of the one or more troubleshooting guides is empty; at least one of the one or more troubleshooting guides has a length that is greater than or equal to a length threshold.

(F8) In the method of any of F1-F7, wherein extracting the features from the data associated with the one or more troubleshooting guides comprises: extracting a feature that indicates whether a troubleshooting guide from the one or more troubleshooting guides includes contact information of a person or a group of persons to be contacted for assistance with the troubleshooting guide.

(F9) In the method of any of F1-F8, wherein extracting the features from the data associated with the one or more troubleshooting guides comprises: extracting a feature that indicates whether at least one of the one or more troubleshooting guides includes a number of commands that is greater than or equal to a threshold number.

(F10) In the method of any of F1-F9, wherein extracting the features from the data associated with the one or more troubleshooting guides comprises: extracting a feature that indicates whether at least one of the one or more troubleshooting guides includes a number of links that is greater than or equal to a threshold number.

(G1) A first example computer program product (FIG. 18, 1818, 1822) comprising a computer-readable storage medium having instructions recorded thereon for enabling a processor-based system (FIG. 1, 102A-102M, 106A-106N; FIG. 7, 700; FIG. 18, 1800) to perform operations. The operations comprise determining (FIG. 2, 202) a schema (FIG. 7, 726) that defines at least a subset of operations that are capable of being performed with regard to a service. The operations further comprise selecting (FIG. 2, 204) a mitigation operation from the operations defined by the schema based at least in part on historical information (FIG. 7, 734), which indicates historical operations that have been performed previously to mitigate issues associated with the service, indicating that the mitigation operation is capable of mitigating a category of issues. The operations further comprise automatically generating (FIG. 2, 206) an executable troubleshooting guide (FIG. 7, 738) in response to selecting the mitigation operation from the operations, the executable troubleshooting guide being configured to perform the mitigation operation.

(H1) A second example computer program product (FIG. 18, 1818, 1822) comprising a computer-readable storage medium having instructions recorded thereon for enabling a processor-based system (FIG. 1, 102A-102M, 106A-106N; FIG. 12, 1200; FIG. 18, 1800) to perform operations. The operations comprise identifying (FIG. 8, 802) an issue that occurs with regard to a service. The operations further comprise analyzing (FIG. 8, 804) historical information (FIG. 12, 1234) to identify historical operations that have been performed previously with regard to one or more services to mitigate issues associated with the one or more services. The operations further comprise selecting (FIG. 8, 806) a mitigation operation from the historical operations based at least in part on the historical information indicating that the mitigation operation is capable of mitigating a category of issues that includes the issue. The operations further comprise automatically generating (FIG. 8, 808) an executable troubleshooting guide (FIG. 12, 1240) in response to selecting the mitigation operation from the historical operations, the executable troubleshooting guide being configured to perform the mitigation operation.

(I1) A third example computer program product (FIG. 18, 1818, 1822) comprising a computer-readable storage medium having instructions recorded thereon for enabling a processor-based system (FIG. 1, 102A-102M, 106A-106N; FIG. 14, 1400; FIG. 18, 1800) to perform operations. The operations comprise extracting (FIG. 13, 1302) features (FIG. 14, 1428) from data (FIG. 14, 1426) associated with one or more troubleshooting guides (FIG. 14, 1432) that are associated with at least one of code or an application programming interface (API). Each troubleshooting guide includes instructions that describe operations to be performed to resolve issues associated with the at least one of the code or the API. Each feature indicates an attribute of at least one troubleshooting guide from the one or more troubleshooting guides. The operations further comprise assigning (FIG. 13, 1304) weights to the respective features using a model (FIG. 14, 1422) based at least in part on key performance indicators (FIG. 14, 1434) associated with the one or more troubleshooting guides. Each key performance indicator specifies an extent to which a respective troubleshooting guide from the one or more troubleshooting guides satisfies one or more criteria. The operations further comprise automatically revising (FIG. 13, 1306) a subset of the one or more troubleshooting guides based at least in part on the weights assigned to the respective features that correspond to the subset of the one or more troubleshooting guides to increase quality of each troubleshooting guide in the subset.

### IV. EXAMPLE COMPUTER SYSTEM

FIG. 18 depicts an example computer 1800 in which embodiments may be implemented. Any one or more of the user devices 102A-102M and/or any one or more of the servers 106A-106N shown in FIG. 1, the computer system 700 shown in FIG. 7, the computer system 1200 shown in FIG. 12, and/or the computing system 1400 shown in FIG. 14 may be implemented using computer 1800, including one or more features of computer 1800 and/or alternative features. Computer 1800 may be a general-purpose computing device in the form of a conventional personal computer, a mobile computer, or a workstation, for example, or computer 1800 may be a special purpose computing device. The description of computer 1800 provided herein is provided for purposes of illustration, and is not intended to be limiting. Embodiments may be implemented in further types of computer systems, as would be known to persons skilled in the relevant art(s).

As shown in FIG. 18, computer 1800 includes a processing unit 1802, a system memory 1804, and a bus 1806 that couples various system components including system memory 1804 to processing unit 1802. Bus 1806 represents one or more of any of several types of bus structures, including a memory bus or memory controller, a peripheral bus, an accelerated graphics port, and a processor or local bus using any of a variety of bus architectures. System memory 1804 includes read only memory (ROM) 1808 and random access memory (RAM) 1810. A basic input/output system 1812 (BIOS) is stored in ROM 1808.

Computer 1800 also has one or more of the following drives: a hard disk drive 1814 for reading from and writing to a hard disk, a magnetic disk drive 1816 for reading from or writing to a removable magnetic disk 1818, and an optical disk drive 1820 for reading from or writing to a removable optical disk 1822 such as a CD ROM, DVD ROM, or other optical media. Hard disk drive 1814, magnetic disk drive 1816, and optical disk drive 1820 are connected to bus 1806 by a hard disk drive interface 1824, a magnetic disk drive interface 1826, and an optical drive interface 1828, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1830, one or more application programs 1832, other program modules 1834, and program data 1836. Application programs 1832 or program modules 1834 may include, for example, computer program logic for implementing any one or more of (e.g., at least a portion of) the troubleshooting guide logic 108, the troubleshooting guide logic 708, the schema logic 712, the selection logic 714, the generation logic 716, the issue identification logic 718, the determination logic 720, the execution logic 722, the troubleshooting guide logic 1208, the issue identification logic 1212, the analysis logic 1214, the selection logic 1216, the generation logic 1218, the determination logic 1220, the comparison logic 1222, the execution logic 1224, the troubleshooting guide logic 1408, the feature extraction logic 1412, the weight assignment logic 1414, the revision logic 1416, the machine learning logic 1418, the natural language processor 1420, flowchart 200 (including any step of flowchart 200), flowchart 300 (including any step of flowchart 300), flowchart 400 (including any step of flowchart 400), flowchart 500 (including any step of flowchart 500), flowchart 600 (including any step of flowchart 600), flowchart 800 (including any step of flowchart 800), flowchart 900 (including any step of flowchart 900), flowchart 1000 (including any step of flowchart 1000), flowchart 1100 (including any step of flowchart 1100), and/or flowchart 1300 (including any step of flowchart 1300), as described herein.

A user may enter commands and information into the computer 1800 through input devices such as keyboard 1838 and pointing device 1840. Other input devices (not shown) may include a microphone, joystick, game pad, satellite dish, scanner, touch screen, camera, accelerometer, gyroscope, or the like. These and other input devices are often connected to the processing unit 1802 through a serial port interface 1842 that is coupled to bus 1806, but may be connected by other interfaces, such as a parallel port, game port, or a universal serial bus (USB).

A display device 1844 (e.g., a monitor) is also connected to bus 1806 via an interface, such as a video adapter 1846. In addition to display device 1844, computer 1800 may include other peripheral output devices (not shown) such as speakers and printers.

Computer 1800 is connected to a network 1848 (e.g., the Internet) through a network interface or adapter 1850, a modem 1852, or other means for establishing communications over the network. Modem 1852, which may be internal or external, is connected to bus 1806 via serial port interface 1842.

As used herein, the terms “computer program medium” and “computer-readable storage medium” are used to generally refer to media (e.g., non-transitory media) such as the hard disk associated with hard disk drive 1814, removable magnetic disk 1818, removable optical disk 1822, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1832 and other program modules 1834) may be stored on the hard disk, magnetic disk, optical disk, ROM, or RAM. Such computer programs may also be received via network interface 1850 or serial port interface 1842. Such computer programs, when executed or loaded by an application, enable computer 1800 to implement features of embodiments discussed herein. Accordingly, such computer programs represent controllers of the computer 1800.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V. CONCLUSION

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a memory; and
a processing system coupled to the memory, the processing system configured to:
extract features from data associated with one or more troubleshooting guides that are associated with at least one of code or an application programming interface (API), each troubleshooting guide including instructions that describe operations to be performed to resolve issues associated with the at least one of the code or the API, each feature indicating an attribute of at least one troubleshooting guide from the one or more troubleshooting guides;
assign weights to the respective features; and
automatically revise a subset of the one or more troubleshooting guides based at least in part on the weights assigned to the respective features that correspond to the subset of the one or more troubleshooting guides to increase quality of each troubleshooting guide in the subset.

2. The system of claim 1, wherein the processing system is configured to:
assign the weights to the respective features using a model based at least in part on key performance indicators associated with the one or more troubleshooting guides, each key performance indicator specifying an extent to which a respective troubleshooting guide from the one or more troubleshooting guides satisfies one or more criteria.

3. The system of claim 1, wherein data associated with the one or more troubleshooting guides are stored across multiple independent clouds.

4. The system of claim 1, wherein the processing system is configured to:
extract at least one of the features from the data associated with the one or more troubleshooting guides by executing code that is include in a troubleshooting guide of the one or more troubleshooting guides.

5. The system of claim 1, wherein the processing system is configured to:
extract the features from the data using a machine learning model, the machine learning model configured to receive the data as input to the machine learning model and further configured to derive the features as outputs of the machine learning model based on the data.

6. The system of claim 1, wherein the processing system is configured to:
extract a feature that indicates at least one of the following attributes:
a readability of at least one of the one or more troubleshooting guides;
a number of users who use at least one of the one or more troubleshooting guides;
a number of times at least one of the one or more troubleshooting guides is viewed.

7. The system of claim 1, wherein the processing system is configured to:
extract a feature that indicates at least one of the following attributes:
an amount of time that users of at least one of the one or more troubleshooting guides dwell on the respective troubleshooting guide;
an extent to which the users of at least one of the one or more troubleshooting guides scroll on the respective troubleshooting guide;
an extent to which language in at least one of the one or more troubleshooting guides is subjective by analyzing the data that is included in the respective troubleshooting guide using natural language processing.

8. The system of claim 1, wherein the processing system is configured to:
extract a feature that indicates at least one of the following attributes:
an amount of time since at least one of the one or more troubleshooting guides was created or updated;
explicit feedback regarding at least one of the one or more troubleshooting guides from users of the respective troubleshooting guide;
at least one of the one or more troubleshooting guides is empty;
at least one of the one or more troubleshooting guides has a length that is greater than or equal to a length threshold.

9. A method, which is implemented by a computing system, comprising:
determining a schema that defines at least a subset of operations that are capable of being performed with regard to a service;
selecting a mitigation operation from the operations defined by the schema based at least in part on historical information, which indicates historical operations that have been performed previously to mitigate issues associated with the service, indicating that the mitigation operation is capable of mitigating a category of issues; and
automatically generating an executable troubleshooting guide in response to selecting the mitigation operation from the operations, the executable troubleshooting guide being configured to perform the mitigation operation.

10. The method of claim 9, further comprising:
identifying an issue that occurs with regard to the service;
determining that the issue is included in the category of issues; and
automatically executing the executable troubleshooting guide to mitigate the issue based at least in part on determining that the issue is included in the category of issues.

11. The method of claim 9, further comprising:
identifying an issue that occurs with regard to the service;
determining that the issue is included in the category of issues;
presenting an inquiry, which inquires whether the executable troubleshooting guide is to be executed to mitigate the issue, based at least in part on determining that the issue is included in the category of issues; and
selectively executing the executable troubleshooting guide to mitigate the issue depending on whether a response that indicates that the executable troubleshooting guide is to be executed is received in response to the inquiry.

12. The method of claim 9, further comprising:
determining that an issue has occurred with regard to the service; and
determining that the mitigation operation is capable of mitigating the issue based at least in part on the issue being included in the category of issues that the mitigation operation is capable of mitigating.

13. The method of claim 9, wherein determining the schema comprises:
determining the schema based at least in part on the operations that have been performed previously to mitigate issues associated with the service, as indicated by the historical information.

14. The method of claim 9, wherein determining the schema comprises:
determining the schema based at least in part on the operations that are capable of being performed with regard to the service being identified in a document associated with a user of the service or in instructions associated with the user of the service.

15. The method of claim 9, wherein automatically generating the executable troubleshooting guide comprises:
automatically generating the executable troubleshooting guide to be conditionally executable such that authentication is a prerequisite for execution of the troubleshooting guide; and
wherein the method further comprises:
providing a request for a credential from a user associated with the service;
comparing the credential that is received in response to the request and a reference credential that corresponds to the user to determine whether the user is authenticated; and
executing the executable troubleshooting guide based at least in part on a determination that the user is authenticated as a result of the credential that is received in response to the request corresponding to the reference credential.

16. The method of claim 9, further comprising:
receiving an indication that a user associated with the service seeks to execute the executable troubleshooting guide;
comparing at least one permission of the user to at least one reference permission; and
executing the executable troubleshooting guide based at least in part on the at least one permission of the user corresponding to the at least one reference permission.

17. A method, which is implemented by a computing system, comprising:
identifying an issue that occurs with regard to a service;
analyzing historical information to identify historical operations that have been performed previously with regard to one or more services to mitigate issues associated with the one or more services;
selecting a mitigation operation from the historical operations based at least in part on the historical information indicating that the mitigation operation is capable of mitigating a category of issues that includes the issue; and
automatically generating an executable troubleshooting guide in response to selecting the mitigation operation from the historical operations, the executable troubleshooting guide being configured to perform the mitigation operation.

18. The method of claim 17, further comprising:
estimating a severity of the issue based at least in part on an extent to which a plurality of key performance indicators associated with the service fails to satisfy one or more criteria as a result of the issue occurring with regard to the service; and
executing the executable troubleshooting guide to mitigate the issue based at least in part on the severity of the issue being greater than or equal to a severity threshold.

19. The method of claim 17, further comprising:
determining an extent to which previous performance of the mitigation operation with regard to at least one service of the one or more services has negatively impacted the at least one service; and
executing the executable troubleshooting guide to mitigate the issue based at least in part on the extent being less than or equal to an extent threshold.

20. The method of claim 17, further comprising:
determining a confidence that performance of the mitigation operation with regard to the service will not negatively impact the service; and
automatically executing the executable troubleshooting guide as a result of the confidence being greater than or equal to a confidence threshold.

21. The method of claim 17, further comprising:
determining a confidence that performance of the mitigation operation with regard to the service will not negatively impact the service; and
requesting authorization to execute the executable troubleshooting guide from a user who is associated with the service as a result of the confidence being less than a confidence threshold.

22. The method of claim 17, further comprising:
determining a subset of the one or more services such that each service in the subset and the service with regard to which the issue is identified have one or more characteristics in common;
wherein selecting the mitigation operation comprises:
selecting the mitigation operation from the historical operations based at least in part on the historical information indicating that the mitigation operation has been performed with regard to at least one service in the subset.

23. The method of claim 17, wherein automatically generating the executable troubleshooting guide comprises:
automatically generating the executable troubleshooting guide to be conditionally executable such that authentication is a prerequisite for execution of the troubleshooting guide; and
wherein the method further comprises:
providing a request for a credential from a user associated with the service;
comparing the credential that is received in response to the request and a reference credential that corresponds to the user to determine whether the user is authenticated; and
executing the executable troubleshooting guide based at least in part on a determination that the user is authenticated as a result of the credential that is received in response to the request corresponding to the reference credential.

24. The method of claim 17, further comprising:
receiving an indication that a user associated with the service seeks to execute the executable troubleshooting guide;
comparing at least one permission of the user to at least one reference permission; and
selectively executing the executable troubleshooting guide based at least in part on whether the at least one permission of the user corresponds to the at least one reference permission.
